(19) United States
(12) Patent Application Publication
(10) Pub. No.: US 2026/0017780 A1
(43) Pub. Date: Jan. 15, 2026

(54) INSPECTION APPARATUS AND INSPECTION SYSTEM

(71) Applicant: CANON KABUSHIKI KAISHA, Tokyo (JP)

(72) Inventor: RIKO MIURA, Tokyo (JP)

(21) Appl. No.: 19/261,631

(22) Filed: Jul. 7, 2025

(30) Foreign Application Priority Data
Jul. 9, 2024 (JP) 2024-110604

(51) Int. Cl. G06T 7/00

(52) U.S. Cl. CPC G06T 7/001; G06T 2207/10008; G06T 2207/30144

(57) ABSTRACT

An inspection apparatus that, based on a reference image, inspects image data acquired from an image formed on a print product, the inspection apparatus includes a reading unit configured to optically read a pre-print sheet on which information is printed in advance to generate read image data, an image processing unit configured to acquire reference data from print data, and a generation unit configured to combine the read image data and the reference data to generate combined image data, wherein the generation unit generates the reference image by performing addition image processing that is a correction process for, based on correction information corresponding to a noise component of light generated by the reading unit, adding the noise component of the light on at least a region corresponding to the reference data in the combined image data.

### BACKGROUND

### Field of the Technology

The present disclosure relates to an inspection apparatus and an inspection system.

### Description of the Related Art

In a print product output from a printing apparatus, dirt may occur by a color material such as ink or toner being attached to an unintended portion. Or color loss may occur because a sufficient color material is not attached to a portion where an image to be formed, and the color is lighter than the original color. Such dirt or color loss decreases the quality of the print product. Accordingly, it is necessary to inspect whether an image of the print product is excellent or poor, and guarantee the quality of the print product.

Visual inspection in which an inspector visually inspects the quality of a print product requires much time and cost. Thus, in recent years, an inspection system that performs an automatic inspection without depending on visual inspection is discussed.

For example, an inspection apparatus that compares an image obtained by a scanner optically reading a print product (hereinafter, an inspection image) and image data to be actually used in printing (hereinafter, a raster image processor (RIP) image) as a reference image is known. Since the inspection image is read by the scanner, a phenomenon termed reflective glare may influence the inspection image.

Under the influence of the reflective glare, a difference occurs between the reference image and the inspection image, and the inspection performance decreases. Accordingly, Japanese Patent Application Laid-Open No. 2020-8543 discusses a method for correcting the influence of reflective glare by comparing a reference image (a RIP image) and an inspection image.

### SUMMARY

According to embodiments of the present disclosure, an inspection apparatus that, based on a reference image, inspects image data acquired from an image formed on a print product is provided, the inspection apparatus including a reading unit configured to optically read a pre-print sheet on which information is printed in advance to generate read image data, an image processing unit configured to acquire reference data from print data, and a generation unit configured to combine the read image data and the reference data to generate combined image data, wherein the generation unit generates the reference image by performing addition image processing that is a correction process for, based on correction information corresponding to a noise component of light generated by the reading unit, adding the noise component of the light on at least a region corresponding to the reference data in the combined image data.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram illustrating an entirety of a printing system.

FIG. 2 is a block diagram illustrating a system configuration of the printing system.

FIG. 3 is a schematic diagram illustrating a mechanical cross-sectional view of an image forming apparatus.

FIG. 4 is a diagram illustrating configurations of line sensor units.

FIG. 5 is a diagram illustrating a configuration of a line sensor.

FIG. 6 is a diagram illustrating a reading position of each line sensor unit.

FIG. 7 is a diagram illustrating an optical path of reflected light by a print product.

FIG. 8 is a diagram illustrating an optical path of reflected light by a print product in a case where a uniform black image having a high image density is printed.

FIG. 9 is an example of a chart for measuring a property of reflective glare.

FIG. 10 is a graph illustrating a distance property of reflective glare.

FIG. 11 is a block diagram illustrating a functional configuration of an inspection apparatus.

FIG. 12 is a flowchart illustrating a processing procedure of an inspection process.

FIG. 13 is a flowchart of a reference image generation process.

FIG. 14 is an example of a weighting coefficient for reproducing reflective glare.

FIGS. 15A to 15D are diagrams illustrating a reflective glare removal process and a reflective glare reproduction process.

FIG. 16 is a flowchart illustrating a processing procedure of a detection process.

FIGS. 17A and 17B are examples of shapes of filters for an emphasis process.

FIG. 18 is an example of a result display screen.

FIG. 19 is an example where a reference image is generated by combining pre-print sheet data and raster image processor (RIP) reference data.

FIG. 20 is a flowchart of a reference image generation process according to a first variation.

FIG. 21 is an example of a calibration recommendation display screen in a case of a new sheet type.

FIG. 22 is an example of a coefficient adjustment screen.

FIGS. 23A to 23D are diagrams illustrating an influence of reflective glare and a reflective glare reproduction process.

FIG. 24 is a flowchart of a reference image generation process.

FIG. 25 is an example of a screen for switching a reflective glare setting.

### DESCRIPTION OF THE EMBODIMENTS

With reference to the attached drawings, exemplary embodiments of the present disclosure will be described in detail. The following exemplary embodiments do not limit the disclosure according to the appended claims, and not all the combinations of the features described in the exemplary embodiments are essential for a method for solving the issues in the present disclosure. The present exemplary embodiments are described using an image forming apparatus as an example of an information processing apparatus, but are not limited to this.

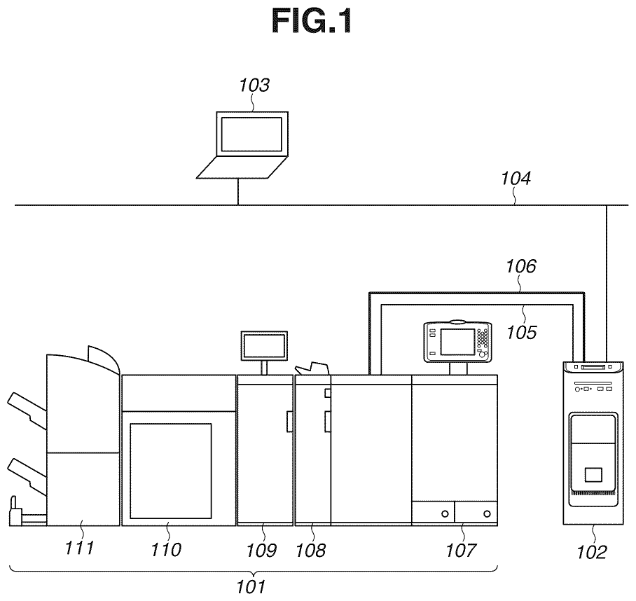

A first exemplary embodiment of the present disclosure will be described. FIG. 1 is a diagram illustrating the entirety of the hardware configuration of an image processing system according to the present exemplary embodiment. The image processing system includes an image forming apparatus 101 and an external controller 102. The image forming apparatus 101 and the external controller 102 are connected together via an internal local area network (LAN) 105 and a video cable 106 so that the image forming apparatus 101 and the external controller 102 can communicate with each other. A configuration may be employed in which the video cable 106 does not have its configuration, and the internal LAN 105 substitutes for the function of the video cable 106. The external controller 102 is connected to a client personal computer (PC) 103 via an external LAN 104 so that the external controller 102 can communicate with the client PC 103. The PC 103 gives a print instruction to the external controller 102.

On the client PC 103, a printer driver having the function of converting print data into a print description language that can be processed by the external controller 102 is installed. A user who performs printing can give a print instruction via the printer driver from various applications. Based on a print instruction from the user, the printer driver transmits print data to the external controller 102. If the external controller 102 receives a print instruction from the PC 103, the external controller 102 performs data analysis and a rasterization process on the print data, inputs the resulting print data to the image forming apparatus 101, and gives a print instruction to the image forming apparatus 101.

Next, the image forming apparatus 101 is described. To the image forming apparatus 101, apparatuses having a plurality of different functions are connected, and the image forming apparatus 101 is configured to perform a complex printing process such as bookbinding.

A printing apparatus 107 forms an image using toner on a sheet conveyed from a sheet feeding section in a lower portion of the printing apparatus 107. The configuration and the operating principle of the printing apparatus 107 are as follows. A ray apparatus causes a rotary polygon mirror such as a polygon mirror to reflect a light beam such as laser light modulated according to image data, and irradiates a photosensitive drum with the reflected laser light as scanning light. An electrostatic latent image formed on the photosensitive drum by the laser light is developed using toner. This developed toner image is transferred to a sheet attached to a transfer drum. A series of operations of this image formation process is sequentially executed using toner of yellow (Y), magenta (M), cyan (C), and black (K), thereby forming a full-color image on the sheet. The sheet on the transfer drum on which the full-color image is formed is conveyed to a fixing device. The fixing device includes a roller and a belt and has a heat source such as a halogen heater built into the roller. The fixing device melts by heat and pressure the toner on the sheet to which the toner image is transferred, thereby fixing the toner to the sheet.

An inserter 108 is an apparatus that inserts an insertion sheet. The inserter 108 can insert a sheet at any position into a group of sheets that is subjected to printing by the printing apparatus 107 and conveyed.

A product inspection apparatus 109 is an apparatus that reads an image on a conveyed sheet and compares the image as an inspection image and a reference image, thereby determining whether the printed image is normal.

A large-capacity stacker 110 is an apparatus capable of stacking a large number of sheets. A finisher 111 is an apparatus that performs a finishing process on a conveyed sheet. The finisher 111 can perform finishing such as stapling, punching, or saddle stitch binding, and discharges a sheet to a sheet discharge tray.

The printing system described with reference to FIG. 1 has a configuration in which the external controller 102 is connected to the image forming apparatus 101. The present disclosure, however, is not limited to a configuration in which the external controller 102 is connected.

That is, the printing system may have a configuration in which the image forming apparatus 101 is connected to the external LAN 104, and the client PC 103 transmits print data that can be processed by the image forming apparatus 101 to the image forming apparatus 101. In the case of this printing system, the image forming apparatus 101 performs data analysis and a rasterization process on the print data and executes a printing process on the resulting print data.

### <System Configuration Diagram>

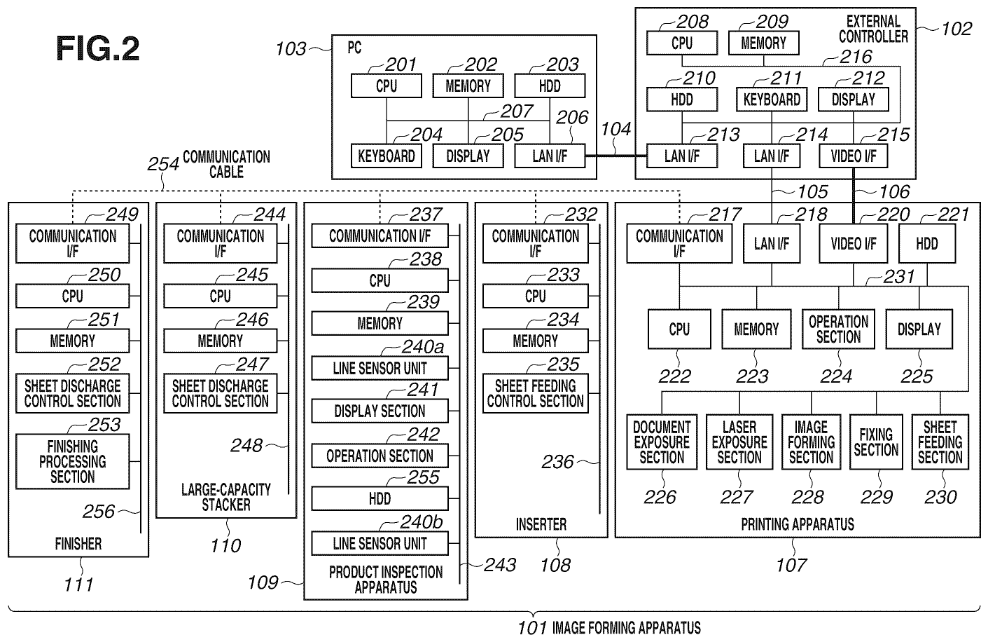

FIG. 2 is a block diagram illustrating the system configuration of the image forming apparatus 101, the external controller 102, and the client PC 103.

First, the configuration of the printing apparatus 107 of the image forming apparatus 101 is described. The printing apparatus 107 of the image forming apparatus 101 includes a communication interface (I/F) 217, a LAN I/F 218, a video I/F 220, a hard disk drive (HDD) 221, a central processing unit (CPU) 222, a memory 223, an operation section 224, and a display 225. The printing apparatus 107 of the image forming apparatus 101 further includes a document exposure section 226, a laser exposure section 227, an image forming section 228, a fixing section 229, and a sheet feeding section 230. These components are connected together via a system bus 231.

The communication I/F 217 is connected to the inserter 108, the product inspection apparatus 109, the large-capacity stacker 110, and the finisher 111 via a communication cable 254, and communication for control of each apparatus is performed via the communication I/F 217.

The LAN I/F 218 is connected to the external controller 102 via the internal LAN 105, and print data is communicated via the LAN I/F 218. The video I/F 220 is connected to the external controller 102 via the video cable 106, and image data is communicated via the video I/F 220.

The HDD 221 is a storage device that saves programs and data. Based on the programs saved in the HDD 221, the CPU 222 comprehensively controls image processing and controls printing. The memory 223 stores programs necessary for the CPU 222 to perform various processes and image data and operates as a work area. The operation section 224 receives inputs of various settings and an instruction to perform an operation from the user. The display 225 displays setting information regarding the image forming apparatus 101 and the processing status of a print job. The document exposure section 226 performs the process of reading a document when a copy function or a scan function is used. The document exposure section 226 captures an image using a complementary metal-oxide-semiconductor (CMOS) image sensor while illuminating a sheet placed by the user with an exposure lamp, thereby reading document data. The laser exposure section 227 is a device that performs primary charging for irradiating the photosensitive drum with laser light to transfer a toner image, and laser exposure. First, the laser exposure section 227 performs primary charging for charging the surface of the photosensitive drum to a uniform negative potential. Next, a laser driver irradiates the photosensitive drum with laser light while adjusting the angle of reflection using a polygon mirror. This neutralizes the negative charge of the irradiated portion, thereby forming an electrostatic latent image. The image forming section 228 is a device that transfers toner to a sheet. The image forming section 228 includes a development unit, a transfer unit, and a toner supply unit. The image forming section 228 transfers toner on the photosensitive drum to a sheet. The development unit attaches negatively charged toner to an electrostatic latent image on the surface of the photosensitive drum from a development cylinder, thereby visualizing the image. The transfer unit performs a primary transfer for applying a positive potential to a primary transfer roller and transferring toner on the surface of the photosensitive drum to a transfer belt, and a secondary transfer for applying a positive potential to a secondary transfer outer roller and transferring the toner on the transfer belt to a sheet.

The fixing section 229 is a device that melts toner on a sheet and firmly fixes the toner to the sheet by heat and pressure. The fixing section 229 includes a heating heater, a fixing belt, and a pressure belt. The sheet feeding section 230 is a device that feeds a sheet. Rollers and various sensors control a sheet feeding operation and a sheet conveyance operation.

Next, the configuration of the inserter 108 of the image forming apparatus 101 is described. The inserter 108 of the image forming apparatus 101 includes a communication I/F 232, a CPU 233, a memory 234, and a sheet feeding control section 235. These components are connected together via a system bus 236. The communication I/F 232 is connected to the printing apparatus 107 via the communication cable 254, and communication necessary for control is performed via the communication I/F 232. According to control programs stored in the memory 234, the CPU 233 performs various types of control necessary for the feeding of a sheet. The memory 234 is a storage device that saves the control programs. Based on an instruction from the CPU 233, the sheet feeding control section 235 controls the feeding and the conveyance of a sheet conveyed from a sheet feeding section of the inserter 108 or the printing apparatus 107 while controlling a roller and a sensor.

Next, the configuration of the product inspection apparatus 109 of the image forming apparatus 101 is described. The product inspection apparatus 109 of the image forming apparatus 101 includes a communication I/F 237, a CPU 238, a memory 239, line sensor units 240a and 240b, a display section 241, an operation section 242, and an HDD 255. These components are connected together via a system bus 243. The communication I/F 237 is connected to the printing apparatus 107 via the communication cable 254, and communication necessary for control is performed via the communication I/F 237. According to control programs stored in the memory 239, the CPU 238 performs various types of control necessary for product inspection. The memory 246 is a storage device that saves the control programs. Based on an instruction from the CPU 238, the line sensor unit 240a or 240b captures a conveyed sheet. The CPU 238 saves an image captured by the line sensor unit 240a or 240b as pre-print sheet data or an inspection image in the memory 239. Further, the CPU 238 compares an inspection image captured by the line sensor unit 240a or 240b and a reference image saved in the memory 239, thereby determining whether a printed image is normal. The method for acquiring the reference image will be described below. The display section 241 displays the result of product inspection and a setting screen. The operation section 242 is operated by the user and receives an instruction to save pre-print sheet data in the product inspection apparatus 109, change the settings of the product inspection apparatus 109, or register a reference image. The HDD 255 saves various pieces of setting information and images necessary for product inspection. The saved various pieces of setting information and images can be reused.

Next, the configuration of the large-capacity stacker 110 of the image forming apparatus 101 is described. The large-capacity stacker 110 of the image forming apparatus 101 includes a communication I/F 244, a CPU 245, a memory 246, and a sheet discharge control section 247. These components are connected together via a system bus 248. The communication I/F 244 is connected to the printing apparatus 107 via the communication cable 254, and communication necessary for control is performed via the communication I/F 244. According to control programs stored in the memory 246, the CPU 245 performs various types of control necessary for the discharge of a sheet. The memory 246 is a storage device that saves the control programs. Based on an instruction from the CPU 245, the sheet discharge control section 247 performs control to convey a conveyed sheet to a stack tray, an escape tray, or the finisher 111 at the subsequent stage.

Next, the configuration of the finisher 111 of the image forming apparatus 101 is described. The finisher 111 of the image forming apparatus 101 includes a communication I/F 249, a CPU 250, a memory 251, a sheet discharge control section 252, and a finishing processing section 253. These components are connected together via a system bus 256. The communication I/F 249 is connected to the printing apparatus 107 via the communication cable 254, and communication necessary for control is performed via the communication I/F 249.

According to control programs stored in the memory 251, the CPU 250 performs various types of control necessary for finishing and the discharge of a sheet. The memory 251 is a storage device that saves the control programs. Based on an instruction from the CPU 250, the sheet discharge control section 252 controls the conveyance and the discharge of a sheet. Based on an instruction from the CPU 250, the finishing processing section 253 controls a finishing process such as stapling, punching, or saddle stitch binding.

Next, the configuration of the external controller 102 is described. The external controller 102 includes a CPU 208, a memory 209, an HDD 210, a keyboard 211, a display 212, a LAN I/F 213, a LAN I/F 214, and a video I/F 215. These components are connected together via a system bus 216.

Based on programs and data saved in the HDD 210, the CPU 208 comprehensively executes the process of receiving print data from the PC 103, raster image processor (RIP) processing on the print data, and the process of transmitting the print data to the image forming apparatus 101. The CPU 208 also performs RIP processing for a reference image. Specifically, in the RIP processing for the reference image, for example, the CPU 208 generates an image by converting a resolution of 600 dpi to 300 dpi. In the RIP processing for the print data, the CPU 208 generates an image without decreasing the resolution. The generated reference image (reference image data) is saved in the memory 239 via the internal LAN 105 and the communication cable 254.

The memory 209 stores programs necessary for the CPU 208 to perform various processes and data and operates as a work area. The HDD 210 stores programs necessary for the operation of a printing process and data. The keyboard 211 is a device for inputting an instruction to operate the external controller 102.

The display 212 displays information regarding an execution application for the external controller 102 using a video signal of a still image or a moving image. The LAN I/F 213 is connected to the client PC 103 via the external LAN 104, and a print instruction is communicated via the LAN I/F 213. The LAN I/F 214 is connected to the image forming apparatus 101 via the internal LAN 105, and a print instruction is communicated via the LAN I/F 214. The external controller 102 can exchange various pieces of data with the printing apparatus 107, the inserter 108, the product inspection apparatus 109, the large-capacity stacker 110, and the finisher 111 via the internal LAN 105 and the communication cable 254. The video I/F 215 is connected to the image forming apparatus 101 via the video cable 106, and print data is communicated via the video I/F 215.

Next, the configuration of the client PC 103 is described. The client PC 103 includes a CPU 201, a memory 202, an HDD 203, a keyboard 204, a display 205, and a LAN I/F 206. These components are connected together via a system bus 207. Based on a document processing program saved in the HDD 203, the CPU 201 creates print data or gives a print instruction. The CPU 201 also comprehensively controls the devices connected to the system bus 207. The memory 202 stores programs necessary for the CPU 201 to perform various processes and data and operates as a work area. The HDD 203 stores programs necessary for the operation of a printing process and data. The keyboard 204 is a device for inputting an instruction to operate the PC 103. The display 205 displays information regarding an execution application for the client PC 103 using a video signal of a still image or a moving image. The LAN I/F 206 is connected to the external LAN 104, and a print instruction is communicated via the LAN I/F 206.

In the above description, the external controller 102 and the image forming apparatus 101 are connected to the internal LAN 105 and the video cable 106, but only need to be configured to transmit and receive data necessary for printing. For example, a configuration may be employed in which the external controller 102 and the image forming apparatus 101 are connected to only the video cable 106. Each of the memories 202, 209, 223, 234, 239, 246, and 251 only needs to be a storage device for holding data and programs. For example, a configuration may be employed in which a volatile random-access memory (RAM), a non-volatile read-only memory (ROM), a built-in HDD, an external HDD, or a Universal Serial Bus (USB) memory is substituted for each of the memories 202, 209, 223, 234, 239, 246, and 251.

### <Image Forming Apparatus>

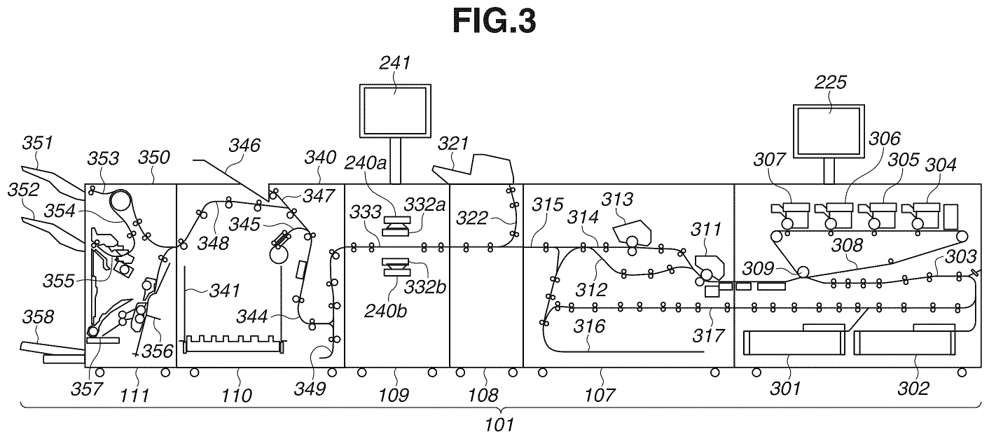

FIG. 3 is a mechanical cross-sectional view of the image forming apparatus 101. The printing apparatus 107 forms an image to be printed on a sheet. Sheet feeding decks 301 and 302 can store various sheets such as a pre-print sheet. Each of the sheet feeding decks 301 and 302 can separate only the top sheet among the stored sheets and convey the separated sheet to a sheet conveyance path 303. Development stations 304 to 307 form toner images using colored toner of Y, M, C, and K, respectively, to form a color image. The toner images formed at this time are primarily transferred to an intermediate transfer belt 308. The intermediate transfer belt 308 rotates clockwise in FIG. 3 and transfers the toner images to the sheet conveyed from the sheet conveyance path 303 at a secondary transfer position 309.

The display 225 displays the printing status of the image forming apparatus 101 or information for the settings of the image forming apparatus 101. A fixing unit 311 fixes the toner images to the sheet. The fixing unit 311 includes a pressure roller and a heating roller. The sheet passes between the rollers, whereby the fixing unit 311 melts and pressure-bonds the toner and fixes the toner images to the sheet. The sheet coming out of the fixing unit 311 passes through a sheet conveyance path 312 and is conveyed to a sheet conveyance path 315. If the toner needs to be further melted and pressure-bonded to fix the toner depending on the type of the sheet, after the sheet passes through the fixing unit 311, the sheet is conveyed to a second fixing unit 313 using an upper sheet conveyance path. After the toner is additionally melted and pressure-bonded, the sheet passes through a sheet conveyance path 314 and is conveyed to the sheet conveyance path 315. If the image forming mode is set to two-sided printing, the sheet is conveyed to a sheet reverse path 316, reversed in the sheet reverse path 316, and then conveyed to a two-sided conveyance path 317. Then, an image is transferred to the second side of the sheet at the secondary transfer position 309.

The inserter 108 for inserting an insertion sheet includes an inserter tray 321 and causes a sheet fed via a sheet conveyance path 322 to join the conveyance path. Consequently, it is possible to insert a sheet at any position into a series of sheets conveyed from the printing apparatus 107 and convey these sheets to the subsequent apparatus.

The sheet passing through the inserter 108 is conveyed to the product inspection apparatus 109. In the product inspection apparatus 109, the line sensor units 240a and 240b are placed opposed to each other. The line sensor unit 240a is a sensor that reads the front side of the sheet, and the line sensor unit 240b is a sensor that reads the back side of the sheet. Between the line sensor unit 240a and a conveyance path 333, skimming-through glass 332a is placed. Between the line sensor unit 240b and the conveyance path 333, skimming-through glass 332b is placed. At the timing when the sheet conveyed to the sheet conveyance path 333 reaches a predetermined position, the product inspection apparatus 109 can read an image on the sheet using the line sensor unit 240a or 240b and determine whether the image on the sheet is normal. The display section 241 displays the result of product inspection performed by the product inspection apparatus 109.

The large-capacity stacker 110 can stack a large number of sheets. The large-capacity stacker 110 includes a stack tray 341 as a tray for stacking a sheet. The sheet passing through the product inspection apparatus 109 is input to the large-capacity stacker 110 through a sheet conveyance path 344. The sheet is conveyed from the sheet conveyance path 344, passes through a sheet conveyance path 345, and is stacked in the stack tray 341. Further, the large-capacity stacker 110 includes an escape tray 346 as a sheet discharge tray. The escape tray 346 is a sheet discharge tray used to discharge a sheet determined as a defective sheet by the product inspection apparatus 109. To output the sheet to the escape tray 346, the sheet is conveyed from the sheet conveyance path 344, passes through a sheet conveyance path 347, and is conveyed to the escape tray 346. To convey the sheet to a post-processing apparatus at the subsequent stage of the large-capacity stacker 110, the sheet is conveyed via a sheet conveyance path 348. A reverse unit 349 reverses the sheet. The reverse unit 349 is used to stack the sheet in the stack tray 341. To stack the sheet in the stack tray 341 so that the direction of the sheet when the sheet is input and the direction of the sheet when the sheet is output are the same as each other, the reverse unit 349 reverses the sheet once. To convey the sheet to the escape tray 346 or the post-processing apparatus at the subsequent stage, the sheet is discharged as it is without flipping the sheet when the sheet is stacked. Thus, the reverse unit 349 does not perform the operation of reversing the sheet.

The finisher 111 is an apparatus that performs a finishing process on the conveyed sheet according to a function specified by the user. Specifically, the finisher 111 has a finishing function such as stapling (one-point or two-point binding), punching (two holes or three holes), or saddle stitch binding. The finisher 111 includes two sheet discharge trays 351 and 352. The sheet is output to the sheet discharge tray 351 via a sheet conveyance path 353. In the sheet conveyance path 353, however, the finishing process such as the stapling cannot be performed. If the finishing process such as the stapling is to be performed, the sheet passes through a sheet conveyance path 354, and a finishing function specified by the user is executed on the sheet by a processing section 355. Then, the sheet is output to the sheet discharge tray 352. Each of the sheet discharge trays 351 and 352 can move up and down, and can also operate such that the sheet discharge tray 351 moves down, and the sheet subjected to the finishing process by the processing section 355 is stacked in the sheet discharge tray 351. If the saddle stitch binding is specified, after a saddle stitch processing section 356 performs the stapling process on the center of the sheet, the sheet is folded in two and output to a saddle stitch binding tray 358 via a sheet conveyance path 357. The saddle stitch binding tray 358 is composed of a conveyor belt and configured to convey a saddle stitch bound bundle stacked on the saddle stitch binding tray 358 to the left.

According to inspection items set in advance, the product inspection apparatus 109 inspects a sent sheet image. The inspection on the sheet image is performed by comparing a reference image set in advance and the sent sheet image. Examples of the method for comparing the images include a method for comparing pixel values with respect to each image position, a method for comparing the positions of objects by edge detection, and a method for extracting character data by optical character recognition (OCR). The inspection items include a shift in the print position, the tint, the density, a streak, fading, and missing print.

<Line Sensor Units 240a and 240b>

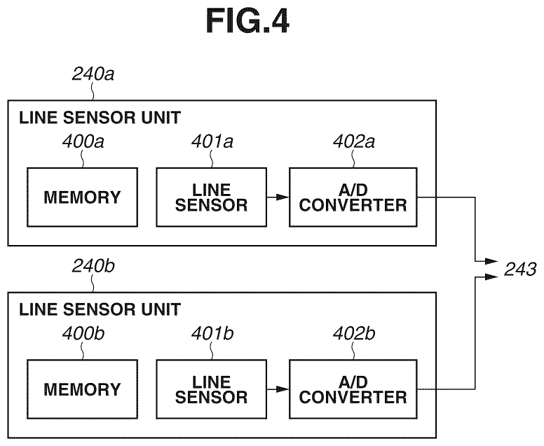

FIG. 4 is a diagram illustrating the configurations of the line sensor units 240a and 240b. The line sensor units 240a and 240b include line sensors 401a and 401b, memories 400a and 400b, and analog-to-digital (A/D) converters 402a and 402b, respectively. For example, each of the line sensors 401a and 401b is a contact image sensor (CIS). The image sensor for reading may not be a CIS, and may be a line scanning camera. The memories 400a and 400b store correction information such as the amount-of-light variation adjustment values of respective pixels of the corresponding line sensors 401a and 401b. The A/D converters 402a and 402b acquire analog signals as the reading results of the line sensors 401a and 401b, respectively. The A/D converters 402a and 402b convert the acquired analog signals into digital signals and transmit the digital signals to the HDD 255. The digital signals are red (R), green (G), and blue (B) read data.

<Line Sensors 401a and 401b>

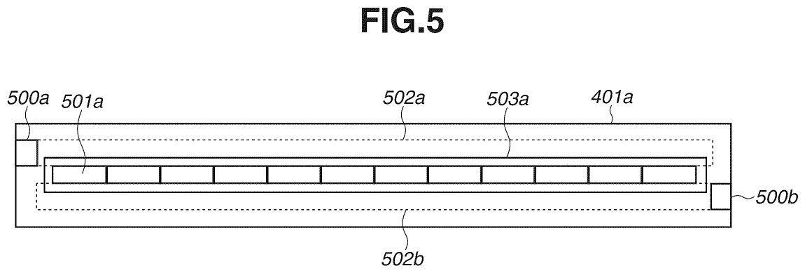

FIG. 5 is a diagram illustrating the configuration of the line sensor 401a. The line sensor 401b also has a similar configuration. The line sensor 401a is an optical sensor including light-emitting portions 500a and 500b, light guiding members 502a and 502b, a lens array 503a, and a sensor chip group 501a. The line sensor 401a is an approximately rectangular parallelepiped and reads an image in its longitudinal direction as the main scanning direction. The line sensors 401a and 401b are attached to the product inspection apparatus 109 so that the main scanning directions of the line sensors 401a and 401b are the same as the main scanning direction of the printing apparatus 107. Thus, the conveyance direction of a sheet as a reading target is the sub-scanning directions of the line sensors 401a and 401b.

For example, each of the light-emitting portions 500a and 500b is a light source composed of a light-emitting diode (LED) that emits white light. In an end portion of the light guiding member 502a, the light-emitting portion 500a is placed. The light guiding member 502a irradiates the sheet with light emitted from the light-emitting portion 500a. In an end portion of the light guiding member 502b, the light-emitting portion 500b is placed. The light guiding member 502b irradiates the sheet with light emitted from the light-emitting portion 500b. The light guiding members 502a and 502b are linearly formed in the main scanning direction. Thus, the line sensor 401a emits light in a straight line in the main scanning direction. The main scanning direction of the line sensor unit 240a and the main scanning direction of the printing apparatus 107 are the same direction.

The lens array 503a is an optical system that guides reflected light by the sheet irradiated with the light emitted from the light-emitting portions 500a and 500b to the sensor chip group 501a. The sensor chip group 501a is a light-receiving portion configured by a plurality of photoelectric conversion elements (sensor chips) being arranged next to each other in a straight line in the main scanning direction. A single sensor chip reads an image of a single pixel. The plurality of sensor chips according to the present exemplary embodiment has a 3-line configuration. To one of the lines, a red (R) color filter is applied. To another one of the lines, a green (G) color filter is applied. To another one of the lines, a blue (B) color filter is applied. The light guided by the lens array 503a forms an image on a light-receiving surface of each sensor chip of the sensor chip group 501a.

The light emitted from the light-emitting portions 500a and 500b is diffused inside the light guiding members 502a and 502b, is also emitted from a portion having curvature, and illuminates the entire region in the main scanning direction of the sheet. The light guiding members 502a and 502b are placed across the lens array 503a in the sub-scanning direction orthogonal to the main scanning direction. Thus, the line sensor 401a has a two-sided illumination configuration in which the lens array 503a (an image reading line) is irradiated with light from the two directions of the sub-scanning direction. The sub-scanning direction of the line sensor unit 240a and the sub-scanning direction of the printing apparatus 107 are the same direction.

### <Principle of Reflective Glare>

Reflective glare refers to a phenomenon where a reading luminance value changes under the influence of reflected light at a main scanning position close to a position of interest. That is, the luminance value of a pixel of interest differs between a case where a peripheral image is dark (the amount of reflected light from the peripheral image is small) and a case where the peripheral image is bright (the amount of reflected light from the peripheral image is great). In a case where the peripheral image is bright, the amount of reflected light from the peripheral image is great, and therefore, the reading luminance value is greater than in a case where the peripheral image is dark.

### <Description of Optical Path of Reflected Light>

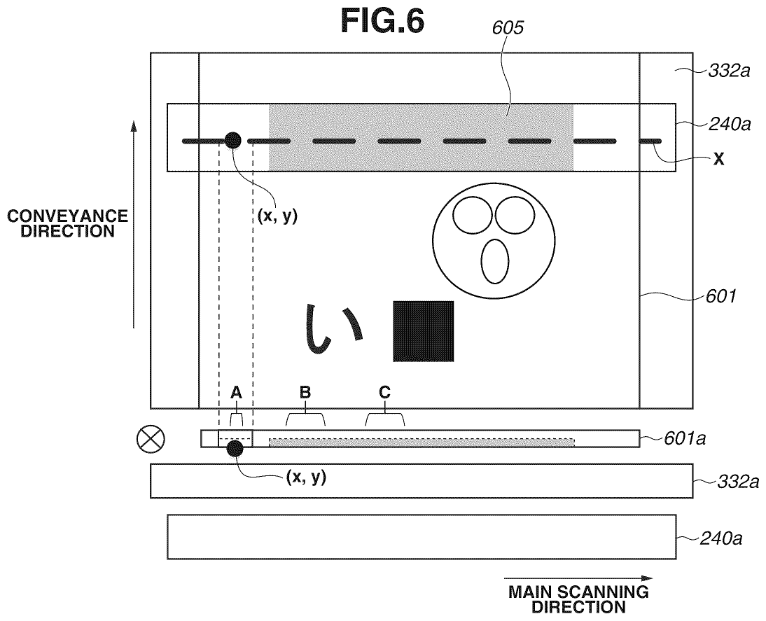

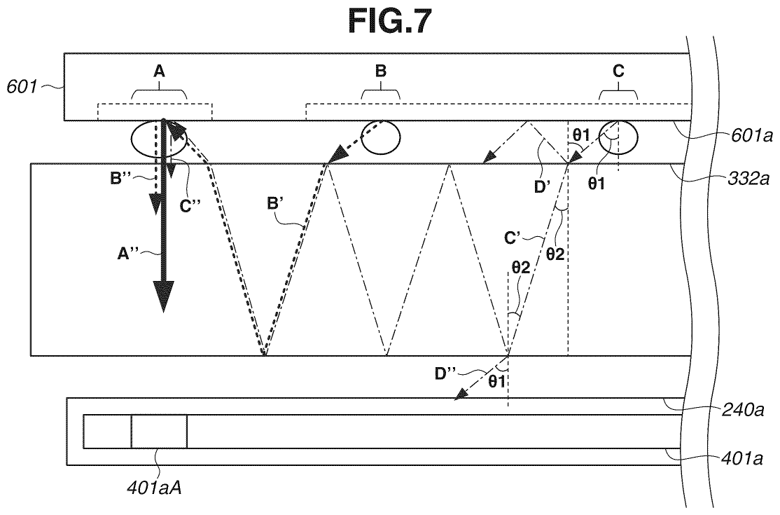

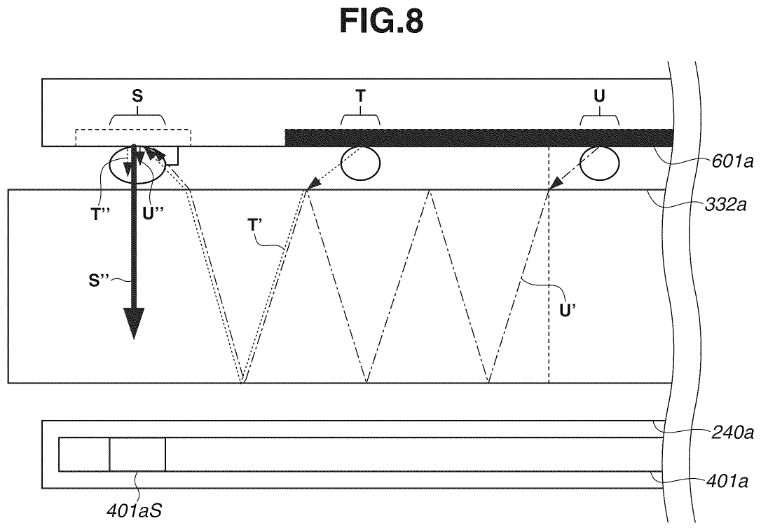

With reference to FIGS. 6, 7, and 8, the optical path of reflective glare is described. FIG. 6 is a diagram illustrating the reading position of each line sensor unit. FIG. 7 is a diagram illustrating the optical path of reflected light by a print product. FIG. 8 is a diagram illustrating the optical path of reflected light by a print product in a case where a uniform black image having a high image density is printed. The reflected light illustrated in FIGS. 7 and 8 is a noise component of light.

First, the reading position of each line sensor unit is described. FIG. 6 is a diagram illustrating the reading position of the line sensor unit 240a. The upper diagram of FIG. 6 is a diagram of a print product 601 passing through a reading position X of the line sensor unit 240a when the print product 601 is viewed from the conveyance path 333 side. The lower diagram of FIG. 6 is a diagram of a print product 601a when the print product 601 is viewed from the downstream side to the upstream side in the conveyance direction of the print product 601. A region A including a pixel of interest is provided. A peripheral region 605 including a predetermined region B and a predetermined region C is provided in the main scanning direction relative to the pixel of interest.

FIG. 7 is a diagram illustrating the optical path of reflected light by the print product 601 when the line sensor unit 240a reads the print product 601. FIG. 7 illustrates reflected light A″ from a pixel of interest (x, y). FIG. 7 illustrates reflected light B′ and reflected light C′ reflected in the skimming-through glass 332a in reflected light from the predetermined regions B and C, respectively. The refraction conditions of the skimming-through glass 332a are represented by the following mathematical expression 1.

$$N 1 * sin θ 1 = N 2 * sin θ 2 \qquad mathematical expression 1$$

N1: the refractive index of the air
N2: the refractive index of the skimming-through glass 332a
θ1: the angle of incidence on the skimming-through glass 332a from the air
θ2: the angle of incidence on the air from the skimming-through glass 332a

The greater the angle θ1 is, the greater the component to be totally reflected in the skimming-through glass 332a is. Thus, the greater the angle θ1 is, the stronger the reflected light from each of the predetermined regions B and C is, and the more likely the reflected light is to reach far. The reflected light B′ and C′ is reflected in the skimming-through glass 332a and irradiates the pixel of interest (x,y), whereby reflected light B″ and C″ is reflected from the pixel of interest (x,y). Based on the distance to the pixel of interest (x,y), the number of reflections of the reflected light C′ in the skimming-through glass 332a is greater than the number of reflections of the reflected light B′ in the skimming-through glass 332a, and the light intensity of the reflected light C′ attenuates more than that of the reflected light B′. Thus, the intensities of the reflected light by the pixel of interest (x,y) have a relationship where the reflected light B″>the reflected light C″.

When reflected light by the predetermined region C is incident on the skimming-through glass 332a, a part of the reflected light is reflected by the upper surface of the skimming-through glass 332a and becomes reflected light D′ that returns to the print product 601. The intensity of the reflected light D′, however, significantly attenuates due to the reflection from the upper surface of the skimming-through glass 332a. Thus, in the reflected light D′, a component that is re-reflected by the print product 601 and incident on the skimming-through glass 332a again, and a component that is repeatedly reflected between the print product 601 and the skimming-through glass 332a and reaches the pixel of interest (x,y) become negligibly small.

Reflected light D″ obtained by the reflected light C′ passing through the lower surface of the skimming-through glass 332a without being totally reflected by the lower surface of the skimming-through glass 332a also exists. The line sensor unit 240a, however, is designed so that the sensor chip group 501a is focused on the print product 601 through the lens array 503a. Thus, the reflected light D″ does not form an image on the line sensor 401a.

With the above configuration, reflected light obtained by adding the reflected light A″, the reflected light B″, and the reflected light C″ forms an image in a reading region 401aA of the line sensor 401a. The intensities of the reflected light B″ and C″ change depending on the light and dark of an image in the peripheral region 605. For example, if an image is not printed in the peripheral region 605, and the peripheral region 605 is the base itself of a sheet having the lowest image density, the intensities of the reflected light B″ and C″ are high.

FIG. 8 is a diagram illustrating the optical path of reflected light by the print product 601 in a case where a uniform black image having a high image density is printed in the peripheral region 605. In the region of interest A, a predetermined region S is provided. In the peripheral region 605, predetermined regions T and U are provided at different positions in the main scanning direction of the line sensor unit 240a. The predetermined region T is provided at a position closer to the predetermined region S than the predetermined region U. The predetermined region S is a white base, and the predetermined regions T and U are black having a uniform image density. Although the predetermined regions S, T, and U have signs different from FIG. 7 for convenience, the indicated regions are the same as the pixel of interest (x,y), the region B, and the region C, respectively.

FIG. 8 illustrates reflected light T′ and U′ reflected in the skimming-through glass 332a in reflected light from the predetermined region T and U, respectively. FIG. 8 illustrates reflected light S″ from the predetermined region S. FIG. 8 illustrates reflected light T″ and U″ obtained by the reflected light T′ and U′ reflected in the skimming-through glass 332a irradiating the predetermined region S. In a reading region 401aS of the line sensor 401a in which reflected light by the predetermined region S forms an image, reflected light obtained by adding the reflected light S″, the reflected light T″, and the reflected light U″ forms an image.

The higher image density the image in the peripheral region 605 has, the smaller the intensity of the reflected light is. Thus, the intensities have relationships where the reflected light T″<the reflected light B″, and the reflected light U″<the reflected light C″. If the image has an even higher image density, and an image having the highest image density that can be printed by the printing apparatus 107 is printed in the peripheral region 605, the intensities have relationships where the reflected light T″<<the reflected light B″, and the reflected light U″<<the reflected light C″. In this case, in the reading region 401aS of the line sensor 401a, almost only the reflected light S″ (=A″) forms an image. This means that the reflected light that forms an image in the reading region 401aS of the line sensor 401 is not influenced by reflective glare from the peripheral region 605. Thus, the luminance value as the reading result of the predetermined region S is accurately read.

In FIG. 8, to enhance the visibility of the drawing, the positions of the reflected light T″, reflected light S″, and reflected light U″ are shifted. In FIG. 7, to enhance the visibility of the drawing, the positions of the reflected light A″, the reflected light B″, and the reflected light C″ are shifted.

### <Reflective Glare Chart>

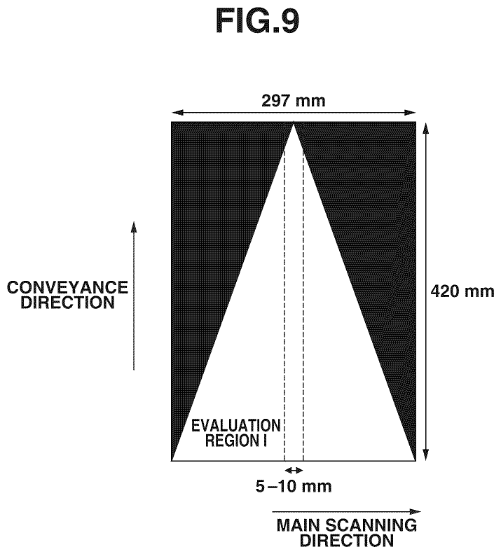

FIG. 9 is a diagram illustrating an example of a chart to be used to acquire reflective glare data. Although FIG. 9 describes dimensions, these are dimensions in an example of an A3 image. As illustrated in FIG. 9, reflective glare data has a white triangular pattern that closes in the sub-scanning direction. The distance property of reflective glare is calculated from the distance from an evaluation region I to a white region in the main scanning direction.

### <Distance Property of Reflective Glare>

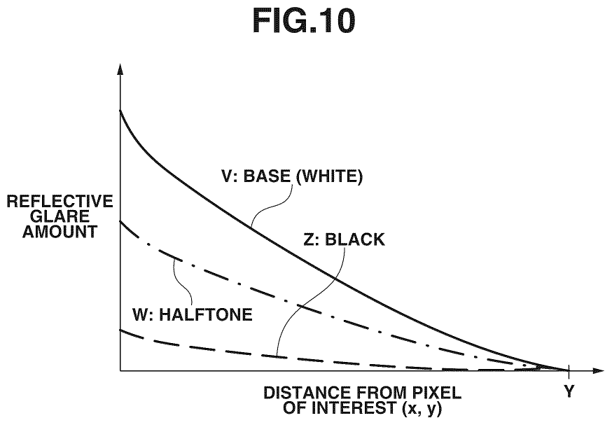

FIG. 10 is a graph illustrating the distance property of reflective glare. The horizontal axis represents the distance from the pixel of interest (x,y). The vertical axis represents the reflective glare amount. A solid line V indicates the distance property in a case where the peripheral region 605 is the base (white) of the sheet. A dashed-dotted line W indicates the distance property in a case where the peripheral region 605 is halftone. A dotted line Z indicates the distance property in a case where the peripheral region 605 is black having the highest image density.

The smaller the distance to the pixel of interest (x,y) is, or the lower the image density is, the greater the reflective glare amount is. Conversely, the greater the distance to the pixel of interest (x,y) is, the smaller the reflective glare amount is. If the distance is a predetermined distance Y, the reflective glare amount is 0. In the present exemplary embodiment, an image to be actually printed is composed of cyan, magenta, yellow, and black colors. The diffusion properties of the colors when the colors are incident differ, and therefore, the distance property of reflective glare differs with respect to each color. The property of the reflective glare amount differs also depending on the paper on which the inspection image is printed.

### <Inspection Process>

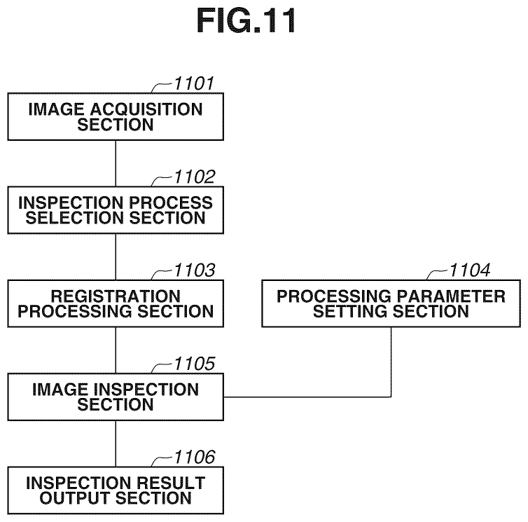

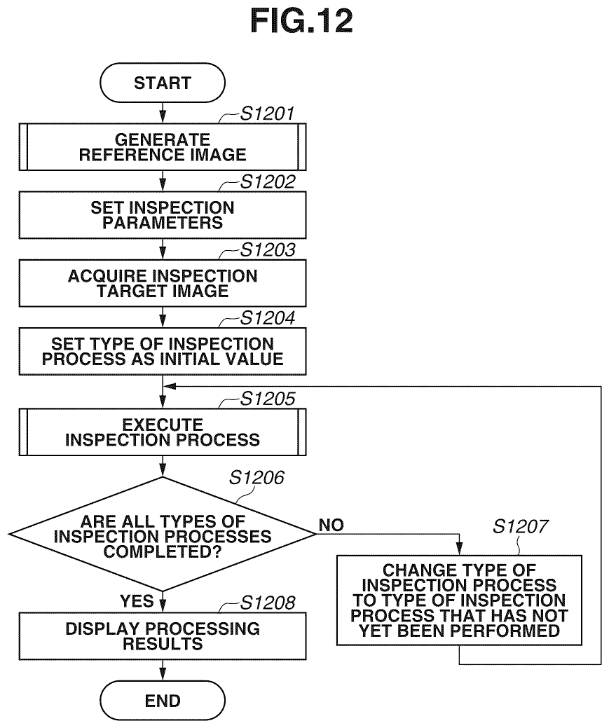

Next, with reference to FIGS. 11 and 12, a description is given of the processing procedure of an inspection process performed by the product inspection apparatus 109 according to the present exemplary embodiment. Processing described below is achieved, for example, by the CPU 238 reading a program stored in a ROM in the memory 239 into a RAM in the memory 239 and executing the program. The step numbers of processes are indicated by figures following “S” below. FIG. 11 is a block diagram illustrating the functional configuration of the product inspection apparatus 109. The functional configuration is executed by the CPU 238 as described above. FIG. 12 is a flowchart of the processing procedure of the inspection process.

In step S1201, an image acquisition section 1101 acquires a reference image from the RAM in the memory 239 or the HDD 255. The reference image data is data generated based on an input provided by the user and is stored in advance in the RAM in the memory 239 or the HDD 255.

The details of the generation of the reference image will be described below.

Next, in step S1202, based on an input provided by the user, an inspection process selection section 1102 and a processing parameter setting section 1104 select a plurality of detection processes to be executed and also set parameters for the plurality of selected detection processes. As a matter of course, only a single detection process can also be selected.

The inspection process selection section 1102 receives the selection of the plurality of detection processes by the user through a selection screen (not illustrated) displayed on the display section 241. On the selection screen, for example, types of defects can be selected, and detection processes for detecting selected defects are selected. Examples of the types of defects may include any types of defects such as image unevenness and the result of a surface shape in addition to a point-shaped defect and a line-shaped (streak) defect described in the present exemplary embodiment. If the user does not select detection processes, detection processes set by default may be selected. The processing parameter setting section 1104 registers parameters for detecting defects selected by the inspection process selection section 1102. The parameters include a filter according to the type of defect and a threshold for distinguishing whether there is a defect. Between the parameters, the threshold is set based on a difference value sent from the product inspection apparatus 109. The detailed processing of the settings of the parameters will be described below.

Further, in step S1203, the image acquisition section 1101 causes the line sensor unit 240a or 240b to read a print product conveyed from the printing apparatus 107, thereby acquiring an inspection target image. A configuration may be employed in which the inspection target image is read in advance by the line sensor unit 240a or 240b, and the read data held in the HDD 255 is acquired.

Next, in step S1204, the inspection process selection section 1102 sets a detection process to be executed among the plurality of detection processes stored in the RAM in the memory 239, as an initial value. The initial value indicates a detection process to be executed first, and if there are not particularly priorities in the order of execution of the detection processes, any order such as the order of selection may be used.

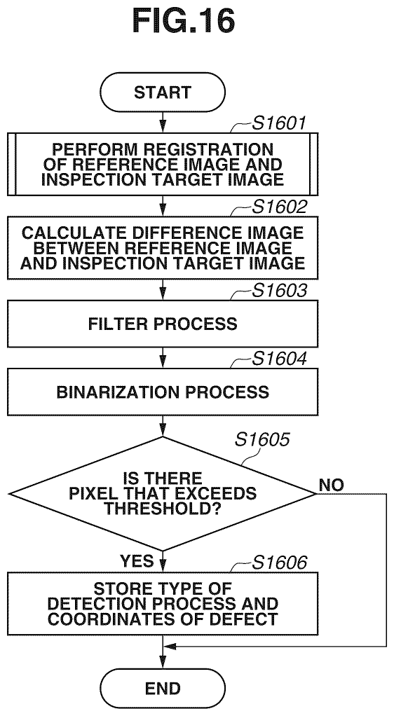

Next, in step S1205, a registration processing section 1103 and an image inspection section 1105 perform registration of the inspection target image and the reference image and also execute the detection process. The details will be described below with reference to FIG. 16.

Then, in step S1206, the image inspection section 1105 determines whether all the selected detection processes are completed. If all the detection processes are completed (Yes in step S1206), the processing proceeds to step S1208. If a detection process that is not completed is left (No in step S1206), the processing proceeds to step S1207.

In step S1207, the inspection process selection section 1102 changes the type of inspection process to a type of inspection process that has not yet been performed, and the processing returns to step S1205. Then, the processes of steps S1205 to S1207 are repeated until all the detection processes are completed. If, on the other hand, all the detection processes are completed, then in step S1208, an inspection result output section 1106 generates inspection results and displays the inspection results on the display section 241. Then, the processing ends. The details of the display process will be described below.

### <Reference Image Generation Process>

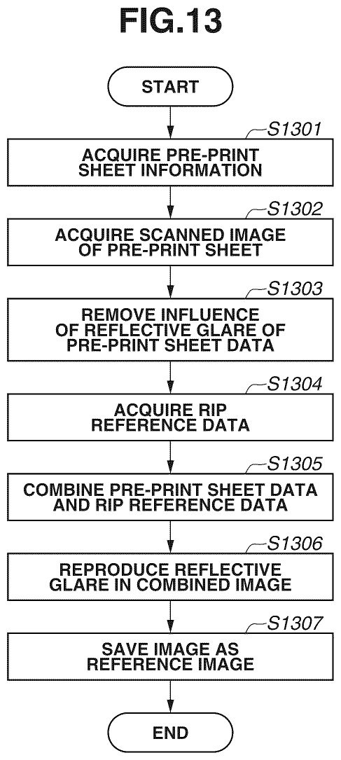

Next, with reference to FIG. 13, a description is given of the processing procedure of the reference image generation process executed in step S1201 by the image acquisition section 1101 according to the present exemplary embodiment. Processing described below is achieved, for example, by the CPU 238 reading a program stored in the ROM in the memory 239 into the RAM in the memory 239 and executing the program. The step numbers of processes are indicated by figures following “S” below.

In step S1301, the image acquisition section 1101 acquires pre-print sheet information. The image acquisition section 1101 receives information regarding pre-print sheets stored in the sheet feeding decks 301 and 302 through a selection screen (not illustrated) displayed on the display section 241. In the present exemplary embodiment, the information regarding each pre-print sheet is the number of sheets of a single pre-print set, the sheet type, the sheet size, the sheet grammage, and the sheet feeding deck in which the pre-print sheet is stored. The image acquisition section 1101 saves the pre-print sheet information in the memory 239.

Next, in step S1302, the image acquisition section 1101 acquires a scanned image of a pre-print sheet. The image acquisition section 1101 receives the start of the scanning of the pre-print sheet through a selection screen (not illustrated) displayed on the display section 241. If the start of the scanning is selected, then according to the pre-print sheet information saved in the memory 239, the image acquisition section 1101 creates RIP image data according to the sheet size of as many blank sheets as the number of sheets of a single set. The RIP image data is data in which all the signal values of cyan, magenta, yellow, and black are 0.

According to the pre-print sheet information, the image acquisition section 1101 transmits an instruction to print blank sheet data on the pre-print sheet to the printing apparatus 107 via the communication I/F 237. The image acquisition section 1101 causes the line sensor unit 240a or 240b to read the blank pre-print sheet on which the blank sheet data is printed by the printing apparatus 107 and which is conveyed. Consequently, the image acquisition section 1101 acquires pre-print sheet data and saves the pre-print sheet data in the memory 239. The “blank pre-print sheet” refers to a sheet on which a printing process based on the blank sheet data is executed and to which a color material is not actually transferred.

Next, in step S1303, the image acquisition section 1101 removes the influence of reflective glare of the pre-print sheet data (read image data) saved in the memory 239. The details of the removal of the influence of the reflective glare will be described below.

Next, in step S1304, the image acquisition section 1101 acquires RIP reference data (reference data). The image acquisition section 1101 performs a color conversion process using a color conversion table generated in advance and stored in the memory 239. As an example, a RIP image is 8 bits per pixel and 600 dpi in the CMYK color space. A read image is 8 bits per pixel and 150 dpi in the RGB color space. The image acquisition section 1101 converts the resolution of the RIP image to the same resolution as that of the read image, namely 150 dpi, and converts the color space of the RIP image from the CMYK color space to the RGB color space using the color conversion table stored in the memory 239. The image acquisition section 1101 saves the RIP image after the conversion as RIP reference data in the memory 239.

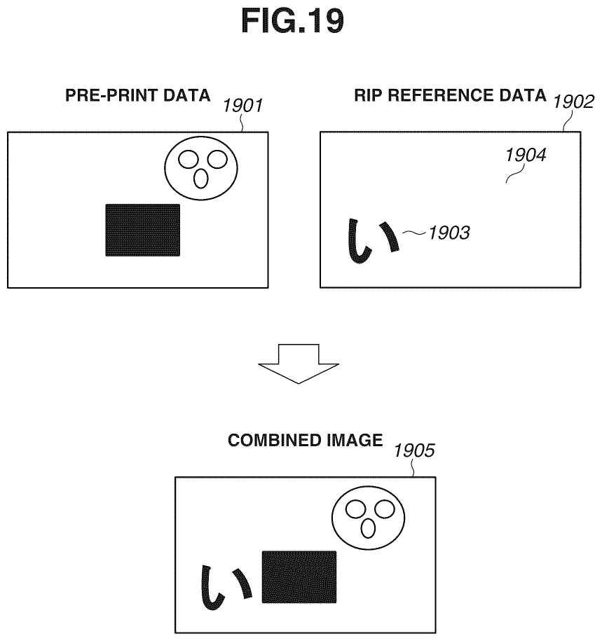

In step S1305, the image acquisition section 1101 combines the pre-print sheet data and the RIP reference data (the reference data) saved in the memory 239, thereby generating combined image data. In the present exemplary embodiment, an image obtained by performing a correction process on the combined image data is referred to as a reference image (a criterion image). With reference to FIG. 19, a case is described where a reference image is obtained by separating RIP reference data into an additional printing portion and a background portion and superimposing the additional printing portion on a pre-print sheet.

FIG. 19 is a schematic diagram illustrating an example of a combining process. RIP reference data 1902 is separated into an additional printing portion 1903 that is a pattern to be printed, and a background portion 1904. As the separation method, for example, there is a method using a histogram. In the histogram, the peak of a high-luminance region is detected, and a binarization threshold is created. A pixel having a luminance lower than the threshold is determined as an additional printing portion, and a pixel having a luminance higher than the threshold is determined as a background portion, thereby creating flag data of each pixel. Specifically, a pixel having a luminance lower than the threshold is set to 1, and a pixel having a luminance higher than the threshold is set to 0, thereby generating flag data of each pixel. The setting of the flag data of each pixel is not limited to the above. A pixel having a luminance lower than the threshold may be set to 0, and a pixel having a luminance higher than the threshold may be set to 1. The image acquisition section 1101 superimposes the separated additional printing portion 1903 on pre-print sheet data 1901, thereby generating a combined image 1905.

Next, in step S1306, the image acquisition section 1101 performs a reflective glare reproduction process on the combined image obtained by the combining. The details of the reproduction of the influence of the reflective glare will be described below.

Further, in step S1307, the image acquisition section 1101 saves an image obtained by reproducing the reflective glare in the combined image, as a reference image in the memory 239. Then, the reference image generation process in step S1201 ends.

### <Removal of Influence of Reflective Glare>

A description is given of a correction process in which in step S1303, the image acquisition section 1101 removes the influence of the reflective glare from the pre-print sheet data. The removal of the influence of the reflective glare refers to the execution of a correction process for attenuating a noise component of light (attenuation image processing). The pre-print sheet data saved in the memory 239 in step S1302 is scan data in the state where an additional printing portion is not printed. That is, the pre-print sheet data is data including the influence of reflective glare in the state where an additional printing portion is not printed, and therefore, it is necessary to remove the influence of the reflective glare before the combining process for combining the pre-print sheet data and the RIP reference data (step S1305). The image acquisition section 1101 reads a weighting coefficient (a correction coefficient) stored in the HDD 255, performs a weighting process on the pixel values of a peripheral image except for a region of interest based on the weighting coefficient, estimates the reflective glare amount, and subtracts the estimated reflective glare amount from a pixel of interest.

The calculation is performed by the following expression.

$${p}^{′} ( x , y ) = f ( x , y ) \{ o ( x , y ) - {\sum }_{j = 0}^{lj} {\sum }_{i = 0}^{li} Fk ( i , j ) p ( x + i - \frac{li}{2} , y + j - \frac{lj}{2} ) \} \qquad mathematical expression 2$$

p(x,y): the pixel value of coordinates (x,y)
p′(x,y): the pixel value after the reflective glare reproduction process
Fk(i,j): the weighting coefficient for reproducing the reflective glare
f(x,y): the reflectance of the pixel of interest
o(x,y): light shed directly on the pixel of interest
li, lj: the reference pixel width

$${\sum }_{j = 0}^{lj} {\sum }_{i = 0}^{li} Fk ( i , j ) p ( x + i - \frac{li}{2} , y + j - \frac{lj}{2} )$$

light reflected from the periphery

Next, the reflectance of the pixel of interest is calculated by the following expression.

$$f ( x , y ) = ( a \times p ( x , y ) - b ) \qquad mathematical expression 3$$

In mathematical expression 3, a and b can be obtained experimentally with values determined in advance.

Next, regarding the pixel of interest p(x,y), the following relational expression holds.

$$p ( x , y ) = f ( x , y ) \{ o ( x , y ) - {\sum }_{j = 0}^{lj} {\sum }_{i = 0}^{li} Fk ( i , j ) p ( x , y ) \} \qquad mathematical expression 4$$

Next, if mathematical expression 4 is deformed, the following expression is obtained.

$$f ( x , y ) o ( x , y ) = p ( x , y ) + f ( x , y ) p ( x , y ) {\sum }_{j = 0}^{lj} {\sum }_{i = 0}^{li} Fk ( i , j ) \qquad mathematical expression 5$$

Next, if mathematical expression 5 is substituted for mathematical expression 2, the following expression is obtained. By the following expression, the reflective glare on the pixel of interest can be reproduced based on the pixel values of the peripheral pixels and the weighting coefficient Fk.

$${p}^{′} ( x , y ) = p ( x , y ) + f ( x , y ) p ( x , y ) {\sum }_{j = 0}^{lj} {\sum }_{i = 0}^{li} Fk ( i , j ) - f ( x , y ) {\sum }_{j = 0}^{lj} {\sum }_{i = 0}^{li} Fk ( i , j ) p ( x + i - \frac{li}{2} , y + j - \frac{lj}{2} ) \qquad mathematical expression 6$$

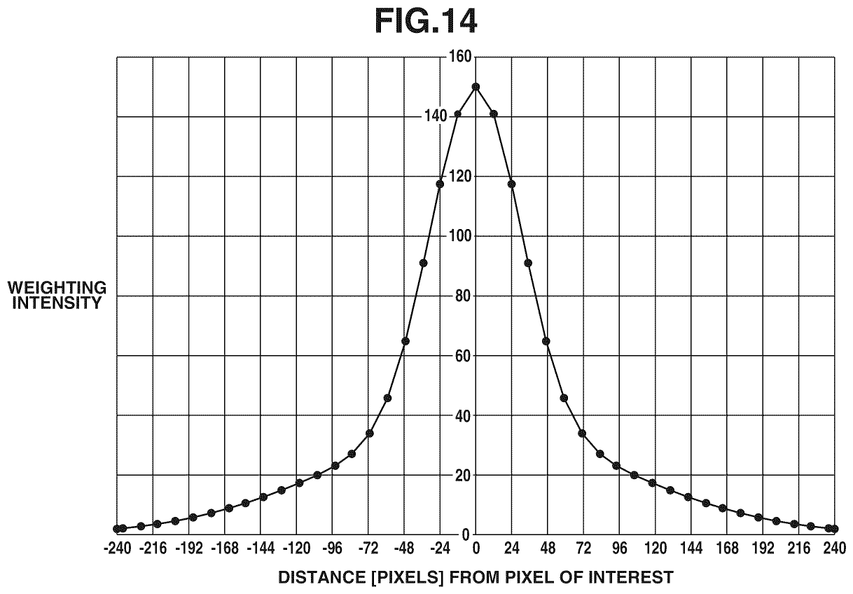

FIG. 14 illustrates an example of the weighting coefficient Fk. The weighting coefficient Fk for reproducing the reflective glare is calculated backward from the distance property illustrated in FIG. 10. Although FIG. 10 illustrates the distance property only on one side of the position of interest, FIG. 14 illustrates the weighting coefficient Fk taking into account left and right peripheral pixels by expanding the property in FIG. 10 to the left and right.

### <Reproduction of Reflective Glare>

A description is given of a correction process in which in step S1306, the image acquisition section 1101 reproduces the reflective glare in the combined image obtained by the combining in step S1305. The reproduction of the reflective glare refers to the execution of a correction process for adding a noise component of light (addition image processing). Since the combined image obtained by the combining in step S1305 is in the state where the combined image is not influenced by reflective glare, it is necessary to execute the reflective glare reproduction process to bring the combined image close to the inspection target image. In the reflective glare reproduction process, correction opposite to the reflective glare removal process in step S1303 is performed. The image acquisition section 1101 performs a weighting process except for the region of interest based on the weighting coefficient acquired in step S1303, estimates the reflective glare amount, and adds the estimated reflective glare amount to the pixel of interest.

The calculation is performed by the following expression.

$${p}^{′} ( x , y ) = f ( x , y ) \{ o ( x , y ) + {\sum }_{j = 0}^{lj} {\sum }_{i = 0}^{li} Fk ( i , j ) p ( x + i - \frac{li}{2} , y + j - \frac{lj}{2} ) \} \qquad mathematical expression 7$$

p(x,y): the pixel value of the coordinates (x,y)
p′(x,y): the pixel value after the reflective glare reproduction process
Fk(i,j): the weighting coefficient for reproducing the reflective glare
f(x,y): the reflectance of the pixel of interest
o(x,y): light shed directly on the pixel of interest
li, lj: the reference pixel width

$${\sum }_{j = 0}^{lj} {\sum }_{i = 0}^{li} Fk ( i , j ) p ( x + i - \frac{li}{2} , y + j - \frac{lj}{2} )$$

light reflected from the periphery

Next, the reflectance of the pixel of interest is calculated by the following expression.

$$f ( x , y ) = ( a \times p ( x , y ) + b ) \qquad mathematical expression 8$$

In mathematical expression 8, a and b can be obtained experimentally with values determined in advance.

Next, regarding the pixel of interest p(x,y), the following relational expression holds.

$$[ Math . 8 ]$$

$$p ( x , y ) = f ( x , y ) \{ o ( x , y ) + {\sum }_{j = 0}^{lj} {\sum }_{i = 0}^{li} Fk ( i , j ) p ( x , y ) \} \qquad mathematical expression 9$$

Next, if mathematical expression 9 is deformed, the following expression is obtained.

$$f ( x , y ) o ( x , y ) = p ( x , y ) - f ( x , y ) p ( x , y ) {\sum }_{j = 0}^{lj} {\sum }_{i = 0}^{li} Fk ( i , j ) \qquad mathematical expression 10$$

Next, if mathematical expression 10 is substituted for mathematical expression 7, the following expression is obtained. By the following expression, the reflective glare on the pixel of interest can be reproduced based on the pixel values of the peripheral pixels and the weighting coefficient Fk.

$${p}^{′} ( x , y ) = p ( x , y ) - f ( x , y ) p ( x , y ) {\sum }_{j = 0}^{lj} {\sum }_{i = 0}^{li} Fk ( i , j ) + f ( x , y ) {\sum }_{j = 0}^{lj} {\sum }_{i = 0}^{li} Fk ( i , j ) p ( x + i - \frac{li}{2} , y + j - \frac{lj}{2} ) \qquad mathematical expression 11$$

### <Effects of Removal of Reflective Glare and Reproduction of Reflective Glare>

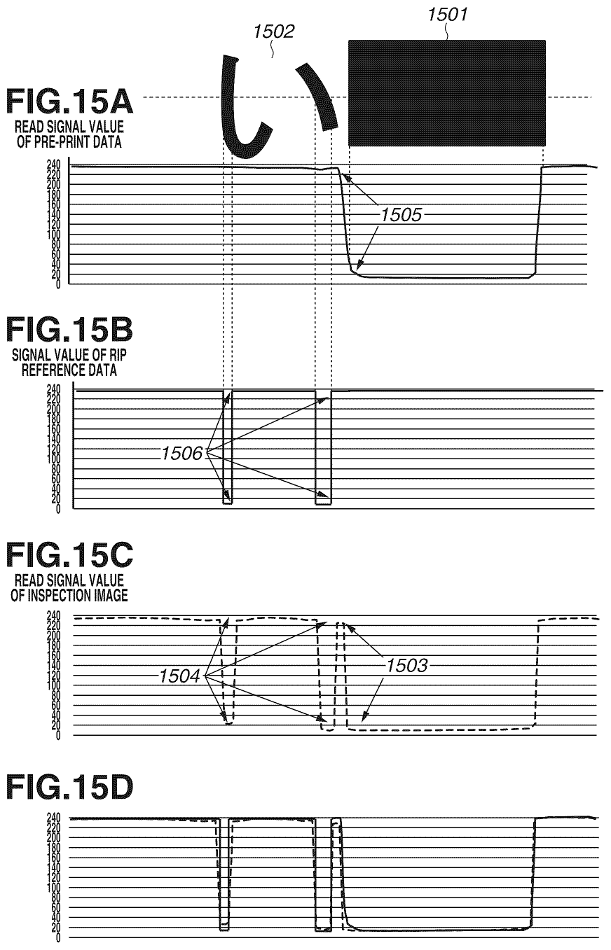

FIGS. 15A to 15D are diagrams illustrating the state of a process. An object 1501 is a part of pre-print sheet data and is an object already printed on a pre-print sheet and read by scanning. An object 1502 is an additional printing portion of RIP reference data and is an object before reflective glare is reproduced.

FIG. 15A illustrates a read signal value in a portion indicated by dotted lines in the object 1501 of the pre-print sheet data on which additional printing is not performed, and the read signal value is a read signal value including the influence of reflective glare when the pre-print sheet is read.

FIG. 15B illustrates a signal value of print data in a portion indicated by dotted lines in the object 1502 of the RIP reference data, and the signal value is a signal value before reflective glare is reproduced. FIG. 15C is a read signal value at the same positions as those in FIGS. 15A and 15B in an inspection image. A read signal value 1503 near an edge portion of the object 1501 in FIG. 15C is influenced by reflective glare of the object 1502 after additional printing. Thus, in the read signal value 1503 near the edge portion of the object 1501, a difference from a read signal value 1505 near the edge in FIG. 15A occurs.

A read signal value 1504 near edges of the object 1502 in FIG. 15C has a difference from a signal value 1506 near the edges in FIG. 15B under the influence of the reflective glare. An inspection apparatus calculates the difference between a reference image and an inspection image and detects a portion having a difference as a defect. Thus, if a difference occurs under the influence of reflective glare, it is determined that a defect is present even though a defect is not present. Thus, the inspection apparatus cannot correctly perform inspection.

Accordingly, in the present exemplary embodiment, the influence of reflective glare of pre-print sheet data is removed, and the influence of reflective glare is reproduced in a combined image after combining (both a region corresponding to read image data and a region corresponding to RIP reference data). This brings a reference image close to an inspection image, and it is possible to improve the inspection accuracy of the inspection apparatus.

A solid line in FIG. 15D indicates a signal value when the pre-print sheet data and the RIP reference data are combined together without correcting the reflective glare. That is, this is a signal value obtained by combining the read signal value of the object 1501 in FIG. 15A and the signal value of the object 1502 in FIG. 15B. A dotted line in FIG. 15D indicates a signal value after the reflective glare correction according to the present exemplary embodiment is executed. That is, this is a signal value after a signal value obtained by removing the reflective glare from the read signal value of the object 1501 in FIG. 15A and the signal value of the object 1502 in FIG. 15B are combined together, and the reflective glare reproduction process is applied.

If FIGS. 15C and 15D are compared, it is understood that the dotted line in FIG. 15D after the reflective glare correction is executed is closer to and less different from the image in FIG. 15C than the original solid line in FIG. 15D.

As described above, after the influence of reflective glare is removed from pre-print sheet data, the pre-print sheet data and RIP reference data are combined together, and reflective glare is reproduced in a combined image (combined image data) obtained by the combining, thereby bringing a reference image close to an inspection image. Thus, it is possible to improve the inspection accuracy.

The method for removing or reproducing reflective glare is not limited to the above. For example, the method may be a method obtained by changing the resolution or the weighting coefficient Fk. To speed up the processing, the resolution may be reduced to two types, namely ¼ and 1/16, and the weighting coefficient Fk may be divided into three types. In the distance property in FIG. 10, if the base of the sheet changes, the reflectance changes. Thus, the distance property fluctuates depending on the sheet. Thus, the weighting coefficient Fk can also be stored in advance with respect to each sheet type in the HDD 255 and switched according to the settings of a selected sheet. The weighting coefficient Fk only needs to be a coefficient for estimating the reflective glare amount. A method for saving the distance property in the HDD 255 and calculating the weighting coefficient Fk may be employed.

### <Detection Process>

Next, with reference to FIG. 16, a description is given of the processing procedure of the detection process executed in step S1205 by the registration processing section 1103 and the image inspection section 1105 according to the present exemplary embodiment. Processing described below is achieved, for example, by the CPU 238 reading a program stored in the ROM in the memory 239 into the RAM in the memory 239 and executing the program. The step numbers of processes are indicated by figures following “S” below.

First, in step S1601, the registration processing section 1103 performs registration of the reference image and the inspection target image. Next, in step S1602, the image inspection section 1105 acquires a difference image between the reference image and the inspection target image, and the processing proceeds to step S1603. For example, the difference image is generated by comparing the reference image and the inspection target image pixel by pixel and acquiring the difference value between the pixel values (e.g., the luminance values with respect to each of RGB) with respect to each pixel.

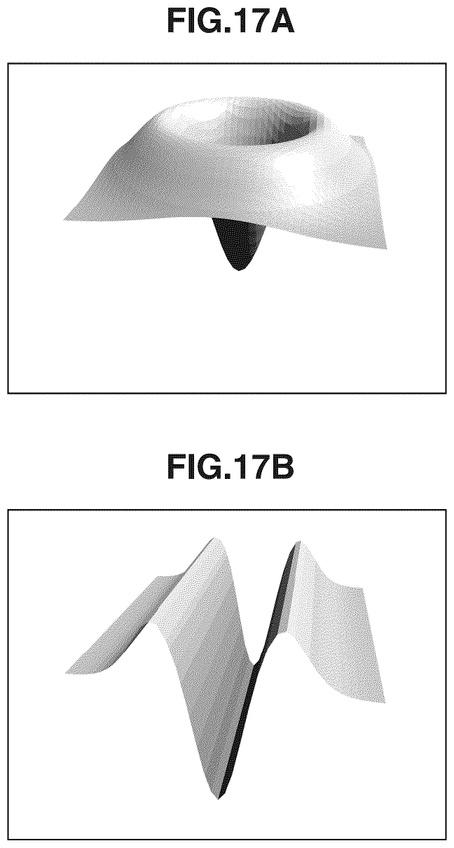

In step S1603, the image inspection section 1105 executes a filter process for emphasizing a particular shape on the difference image acquired in step S1602. As an example, FIG. 17A illustrates a filter for emphasizing a point-like defect. FIG. 17B illustrates a filter for emphasizing a line-like defect. These filters are changed according to the type of the detection process selected in step S1204.

For example, if the detection of a point-like defect is selected as the detection process, the process is executed using the filter illustrated in FIG. 17A. If the detection of a line-like defect is selected as the detection process, the process is executed using the filter illustrated in FIG. 17B.

Next, in step S1604, the image inspection section 1105 executes a binarization process on the difference image subjected to the emphasis process so that a pixel is set to “1” if the difference value exceeds a threshold, and a pixel is set to “O” if the difference value is less than or equal to the threshold.

Next, in step S1605, the image inspection section 1105 determines whether there is a pixel that exceeds the threshold and is set to “1” in the image subjected to the binarization process. If there is a pixel that exceeds the threshold (Yes in step S1605), the processing proceeds to step S1606. If there is not a pixel that exceeds the threshold (No in step S1605), it is determined that a defect portion is not present. Then, this processing ends.

In step S1606, the image inspection section 1105 determines that a defect portion is present, and stores the type of the detection process in which the defect portion is detected and the coordinates of the defect portion in association with each other. Then, the processing ends. The processing described above with reference to the flowchart in FIG. 16 is a subroutine of step S1205 and illustrates the flow of a single detection process. Thus, every time the subroutine of step S1205 is called, the selected type of detection process is executed, and the filter process corresponding to the selected type (step S1603) is executed.

Although in the present exemplary embodiment, a description has been given using as examples of the detection process the process of detecting a point-like defect and the process of detecting a line-like defect, the detection process is not limited to these. That is, this configuration is applicable to any process capable of detecting a defect desired by the user, and the type of the process is not limited.

### <Processing Parameters>

The processing parameters (the detection parameters) set in step S1202 by the processing parameter setting section 1104 are described. As described above, in the present exemplary embodiment, the filter process (step S1603) and the binarization process (step S1604) are executed on the acquired difference image. At this time, if the shape of the filter illustrated in FIG. 17A is made smaller, as a result, a point-like defect of a smaller size is emphasized and more likely to be detected. If the threshold for the binarization process is made smaller, a smaller difference exceeds the threshold, indicates “1” in the binarization process, and is detected as a defect. That is, it is possible to detect a defect having a smaller contrast. As described above, the parameter regarding the size of the filter and the threshold for detection are set as the processing parameters in step S1202.

### <Detection Result Display Method>

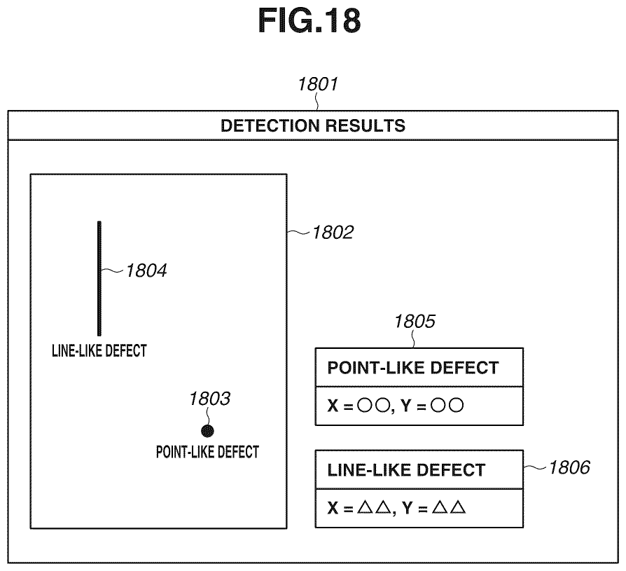

The detection results displayed in step S1208 by the inspection result output section 1106 are described in detail. FIG. 18 illustrates an example of a result display screen according to the present exemplary embodiment. A user interface (UI) screen 1801 displays an overall image 1802 of an inspection target image. For example, it is determined that a defect 1803 detected using the filter in FIG. 17A is a point-like defect. Characters “point-like defect” are additionally displayed near the defect 1803. It is determined that a defect 1804 detected using the filter in FIG. 17B is a line-like defect. Characters “line-like defect” are additionally displayed near the defect 1804. Further, as illustrated in portions 1805 and 1806, the coordinates of the defects may be additionally displayed.

However, the method for displaying the inspection results is not limited to the above method. The method is not limited so long as it is understandable which process among the plurality of detection processes detects a detected defect, for example, by displaying each type of detection process in a different color.

### <Effects of This Image Processing>

According to the present exemplary embodiment, after the influence of reflective glare of pre-print sheet data is removed, the pre-print sheet data is combined with RIP reference data, and the influence of reflective glare is reproduced in a combined image obtained by the combining. As a result, the difference between an inspection image influenced by reflective glare and a reference image becomes small, and it is possible to prevent a decrease in the defect detection accuracy.

In the present exemplary embodiment, the reflective glare reproduction process is performed on a combined image, thereby bringing a reference image close to an inspection image. Conversely, a reflective glare correction process can also be performed on an inspection image, thereby bringing the inspection image close to a reference image. Specifically, image processing for attenuating reflective glare is performed on an inspection image, and image processing for attenuating reflective glare is performed on read image data. Then, the read image data is combined with RIP reference data, and a combined image generated by the combining is used as a reference image.

### (First Variation)

In the first exemplary embodiment, a case has been described where the influence of reflective glare is removed and reflective glare is reproduced using the weighting coefficient Fk saved in advance in the HDD 255. In the distance property in FIG. 10, if the base of the sheet changes, the reflectance changes. Thus, the distance property fluctuates depending on the sheet. When the weighting coefficient Fk is saved in advance in the HDD 255 with respect to each sheet, and if inspection is performed on a sheet type that is not saved, the inspection can be executed with higher accuracy by newly acquiring the weighting coefficient Fk. Accordingly, in a first variation, a case is described where in the case of a new sheet type, the weighting coefficient Fk is acquired, reflective glare is removed, and reflective glare is reproduced.

Only the differences from the first exemplary embodiment are described in detail below.

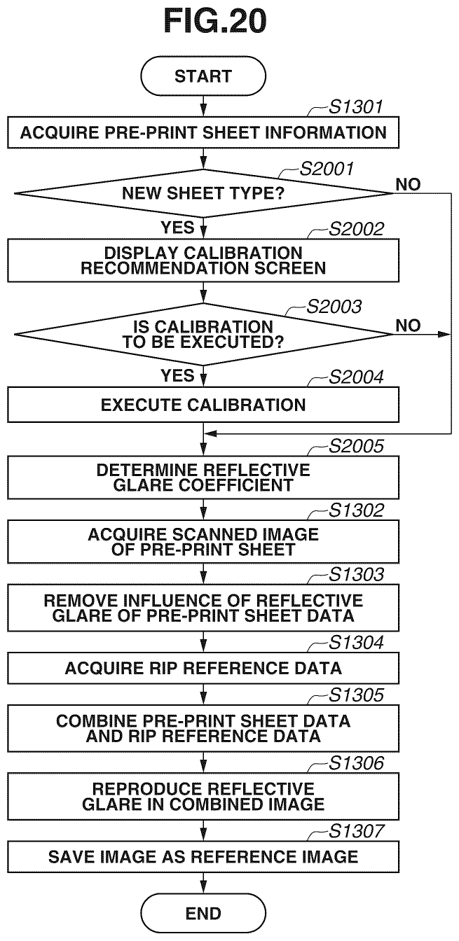

With reference to FIG. 20, a description is given of the processing procedure of the reference image generation process executed in step S1201 by the image acquisition section 1101 according to the present exemplary embodiment. In step S2001, the image acquisition section 1101 determines whether the type of sheet acquired in step S1301 is present among the types of sheets corresponding to the weighting coefficient Fk saved in the HDD 255 (whether the type of sheet acquired in step S1301 is a new sheet type). If the type of sheet acquired in step S1301 is a new sheet type (Yes in step S2001), the processing proceeds to step S2002. If the type of sheet acquired in step S1301 is an already saved sheet type (No in step S2001), the processing proceeds to step S2005.

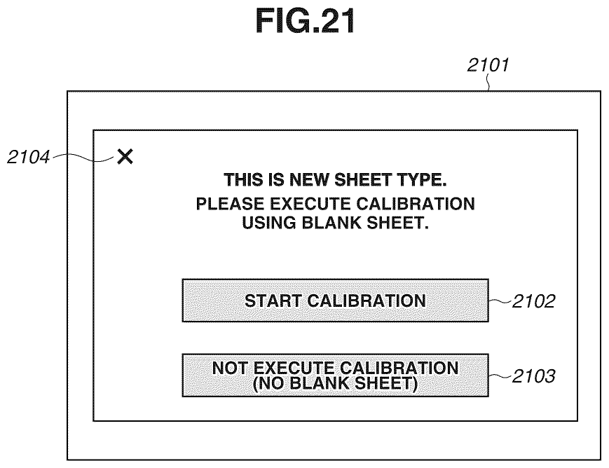

Next, in step S2002, the image acquisition section 1101 recommends calibration to acquire the weighting coefficient Fk in the case of a new sheet type. FIG. 21 is an example of a display screen that notifies the user of a recommendation to execute the calibration. A UI screen 2101 displays a message indicating a new sheet type and a message indicating a recommendation for the calibration. In the calibration, the reflective glare chart used to acquire reflective glare data in FIG. 9 is printed on a sheet, the reflective glare chart after the printing is read, and the weighting coefficient Fk is acquired. Thus, the calibration requires a blank sheet of the same sheet type as that of a pre-print sheet. If the user owns the blank sheet, the image acquisition section 1101 recommends executing the calibration.

Next, in step S2003, the image acquisition section 1101 determines whether to perform the calibration. If a “start calibration” button 2102 is pressed (Yes in step S2003), the processing proceeds to step S2004. For example, when the user does not own the blank sheet of the same sheet type as that of the pre-print sheet, if a “not execute calibration” button 2103 or a “close screen” button 2104 is pressed (No in step S2003), the processing proceeds to step S2005.

Next, in step S2004, the image acquisition section 1101 executes the calibration and acquires the weighting coefficient Fk. Specifically, the image acquisition section 1101 transmits an instruction to print the reflective glare chart in FIG. 9 to the printing apparatus 107. The image acquisition section 1101 causes the line sensor unit 240a or 240b to read a print product printed by the printing apparatus 107, thereby acquiring reflective glare data. Further, the image acquisition section 1101 acquires the distance property of the sheet type from the reflective glare data and acquires the weighting coefficient Fk by back calculation. The image acquisition section 1101 saves the acquired weighting coefficient Fk and the recording sheet type in association with each other in the HDD 255.

Next, in step S2005, the image acquisition section 1101 determines a reflective glare coefficient. The image acquisition section 1101 adopts the weighting coefficient Fk for the corresponding sheet type saved in the HDD 255, as a reflective glare coefficient for the type of the pre-print sheet acquired in step S1301 and reads the reflective glare coefficient from the HDD 255.

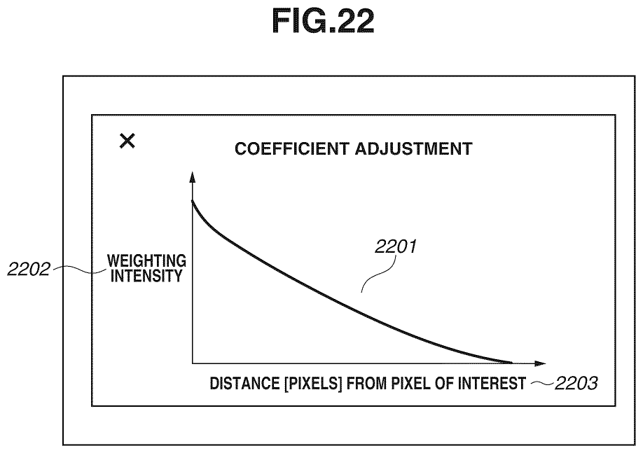

If a corresponding sheet type is not present (if the user does not own the blank sheet of the same sheet type as that of the pre-print sheet, and the calibration cannot be executed as in a case where the determination is No in step S2003), for example, the image acquisition section 1101 adopts the default weighting coefficient Fk and reads the default weighting coefficient Fk from the HDD 255. A method for selecting a sheet type having a close surface property through a selection screen (not illustrated) displayed on the display section 241, or a method for automatically selecting a sheet type having a close surface property may be employed. Further, a method in which the user adjusts the coefficient displayed on the display section 241 may be employed. FIG. 22 illustrates an example of the display of an adjustment screen for adjusting the weighting coefficient. The user can adjust a weighting intensity 2202 and a distance from a pixel of interest 2203 in a distance property 2201 displayed on the display section 241 according to the surface property of a sheet. The weighting coefficient Fk is calculated according to the adjusted distance property and adopted as a reflective glare coefficient.

In the first variation, even in the case of a new sheet type, a reflective glare coefficient can be determined according to the surface property of a sheet. Thus, it is possible to correct reflective glare more accurately, and the detection accuracy improves.

A second exemplary embodiment of the present disclosure will now be described. In the first exemplary embodiment, a description has been given of the process of removing the influence of reflective glare of pre-print sheet data, combining the pre-print sheet data with a reference image, and reproducing reflective glare in the reference image (hereinafter, a detailed correction). In the second exemplary embodiment, a description is given of the process of, while leaving the influence of reflective glare of pre-print sheet data, reproducing reflective glare in RIP reference data, and combining the pre-print sheet data with a reference image (hereinafter, a simplified correction).

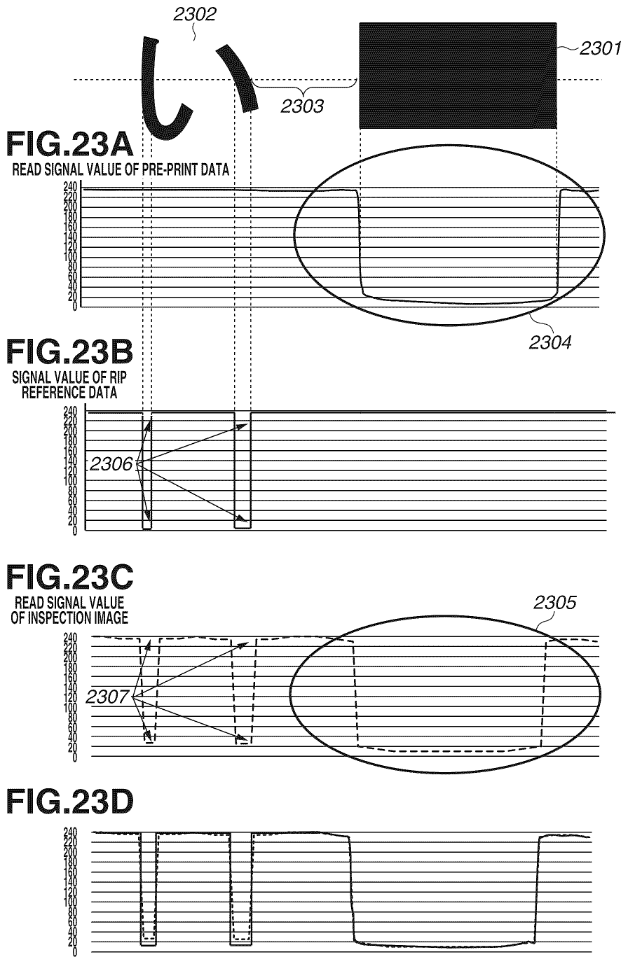

FIGS. 23A to 23D are diagrams illustrating the state of a reflective glare process according to the present exemplary embodiment. A case is considered where the influences of reflective glare of an object 2301 of pre-print sheet data and an object 2302 of additional printing data in FIGS. 23A to 23D on each other are small.

FIG. 23A illustrates a read signal value in a portion indicated by dotted lines in the object 2301 of the pre-print sheet data in the state before additional printing is performed, and the read signal value is a read signal value including the influence of reflective glare when a pre-print sheet is read.

FIG. 23B illustrates a signal value in a portion indicated by dotted lines in the object 2302 of RIP reference data. The signal value is a signal value before reflective glare is reproduced. FIG. 23C illustrates a read signal value at the same positions as those in FIGS. 23A and 23B in an inspection image. FIG. 23D illustrates a solid line which is a signal value obtained by combining data in FIGS. 23A and 23B without correcting reflective glare, and a dotted line which is a signal value obtained by removing reflective glare in FIG. 23A, then combining data in FIGS. 23A and 23B, and reproducing reflective glare.

When a distance 2303 between the objects 2301 and 2302 is sufficiently great, the influences of the reflective glare of the objects 2301 and 2302 on each other are small. Thus, the read signal value of the object 2301 originally present in the pre-print sheet has little difference between a read signal value 2304 in FIG. 23A before the additional printing and a read signal value 2305 in FIG. 23C after the additional printing. In contrast, in the object 2302 that is an additional printing portion, a difference occurs between a signal value 2306 near edges in FIG. 23B that is the signal value of the RIP reference data and a read signal value 2307 near edges in FIG. 23C that is influenced by the reflective glare when the inspection image is read. That is, it is understood that there is a difference only in the signal value of the RIP reference data (FIG. 23B). Accordingly, if the influences of the reflective glare of the pre-print sheet data and the additional printing data on each other are small (if the distance 2303 is sufficiently great), the reflective glare may be reproduced only in the additional printing portion of the RIP reference data. As a result, it is possible to reproduce reflective glare by speeding up the processing without removing the influence of reflective glare.

Only the differences from the first exemplary embodiment are described in detail below.

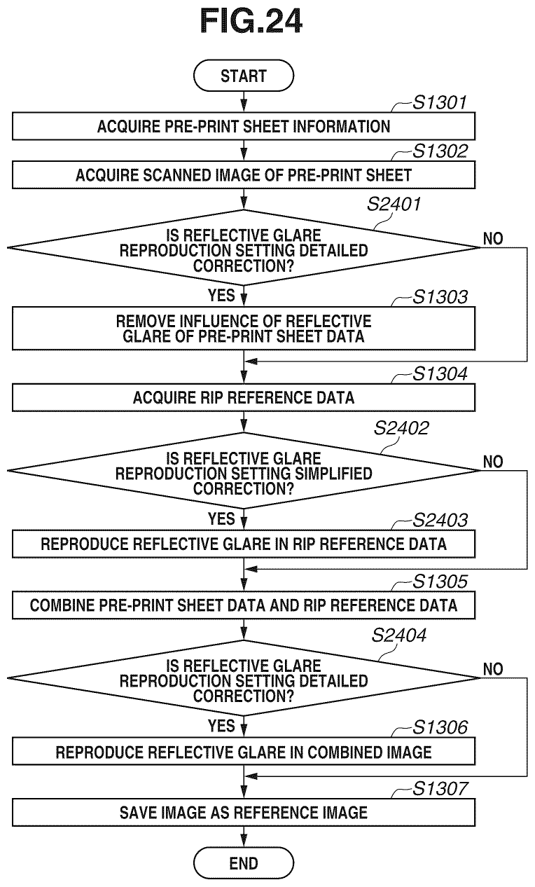

With reference to FIG. 24, a description is given of the processing procedure of the reference image generation process executed in step S1201 by the image acquisition section 1101 according to the present exemplary embodiment. Processing described below is achieved, for example, by the CPU 238 reading a program stored in the ROM in the memory 239 into the RAM in the memory 239 and executing the program. The step numbers of processes are indicated by figures following “S” below.

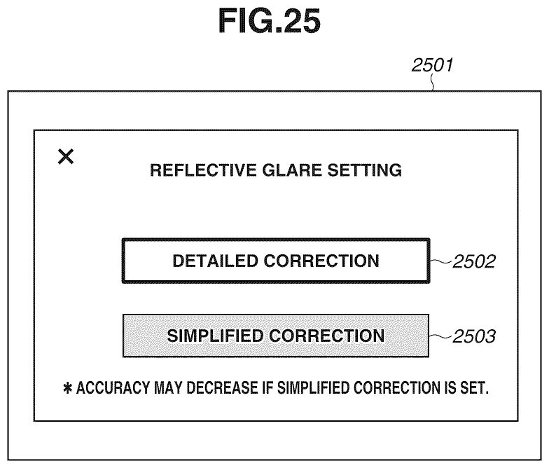

In step S1301, the image acquisition section 1101 acquires pre-print sheet information. FIG. 25 is an example of a setting screen where the detailed correction and the simplified correction of the reflective glare reproduction process can be set. A case is described where the setting of the detailed correction or the simplified correction of the reflective glare reproduction process is selected through the selection screen (FIG. 25) displayed together with pre-print sheet information on the display section 241. If the user determines that pre-print sheet data and an additional printing portion of RIP reference data are sufficiently away from each other, the user sets the simplified correction.

That is, in the case of FIGS. 23A to 23D, if the user determines that the distance 2303 between the objects 2301 and 2302 is sufficiently great, the user sets the simplified correction. Also if a blank sheet of a pre-print sheet is not present because of a new sheet type, and therefore, the influence of reflective glare of a portion of the pre-print sheet is adopted as it is, the simplified correction may be selected. If a “simplified correction” button 2503 is pressed, the image acquisition section 1101 sets a flag for the simplified correction to 1, sets a flag for the detailed correction to 0, and saves the flags in the memory 239. If the user determines that the pre-print sheet data and the additional printing portion of the RIP reference data are close to each other, the user can also set the detailed correction. If a “detailed correction” button 2502 is pressed, the image acquisition section 1101 sets the flag for the detailed correction to 1, sets the flag for the simplified correction to 0, and saves the flags in the memory 239.

Next, in step S1302, the image acquisition section 1101 acquires a scanned image of a pre-print sheet.

Next, in step S2401, the image acquisition section 1101 determines whether the reflective glare reproduction setting is the detailed correction. If the flag for the detailed correction of the reflective glare reproduction setting saved in the memory 239 is 1 (Yes in step S2401), the processing proceeds to step S1303. If the flag for the detailed correction of the reflective glare reproduction setting saved in the memory 239 is 0 (No in step S2401), the processing proceeds to step S1304. Next, if the reflective glare reproduction process is the detailed correction, then in step S1303, the image acquisition section 1101 executes a reflective glare removal process on the pre-print sheet data.

Next, in step S1304, the image acquisition section 1101 acquires RIP reference data. Next, in step S2402, the image acquisition section 1101 determines whether the reflective glare reproduction setting is the simplified correction. If the flag for the simplified correction of the reflective glare reproduction setting saved in the memory 239 is 1 (Yes in step S2402), the processing proceeds to step S2403. If the flag for the simplified correction of the reflective glare reproduction setting saved in the memory 239 is 0 (No in step S2402), the processing proceeds to step S1305.

Next, if the reflective glare reproduction process is the simplified correction, then in step S2403, the image acquisition section 1101 reproduces reflective glare in the entirety of the RIP reference data. The reflective glare reproduction process is executed according to the pre-print sheet information saved in the memory 239 in step S1301. Further, the image acquisition section 1101 saves the RIP reference data after the reflective glare is reproduced in the memory 239.

Next, in step S1305, the image acquisition section 1101 combines the pre-print sheet data including the influence of reflective glare when the pre-print sheet is read and an additional printing portion of the RIP reference data.

Next, in step S2404, the image acquisition section 1101 determines whether the reflective glare reproduction setting is the detailed correction. If the flag for the detailed correction of the reflective glare reproduction setting saved in the memory 239 is 1 (Yes in step S2404), the processing proceeds to step S1306. If the flag for the detailed correction of the reflective glare reproduction setting saved in the memory 239 is 0 (No in step S2404), the processing proceeds to step S1307. In step S1307, the image acquisition section 1101 saves the combined image as a reference image in the memory 239.

In the reflective glare reproduction setting, it is only necessary to set the detailed correction or the simplified correction. For example, a configuration may be employed in which the detailed correction is set as default, and the on and off states of the simplified correction can be set. The user may not select the detailed correction or the simplified correction, and a method for acquiring pre-print sheet data and RIP reference data, then acquiring the distance between objects in the pre-print sheet data and the RIP reference data (the distance 2303 in FIGS. 23A to 23D), and automatically setting the simplified correction if the distance is greater than or equal to a threshold may be employed.

### <Effects of This Image Processing>

According to the present exemplary embodiment, while the influence of reflective glare of pre-print sheet data is left, the pre-print sheet data is combined with a reference image, whereby it is possible to speed up the reproduction of reflective glare. Reflective glare of RIP reference data is reproduced, and the pre-print sheet data and the reference image are combined together, whereby it is possible to prevent a decrease in the defect detection accuracy.

### Other Exemplary Embodiments

The present disclosure can also be achieved by the process of supplying a program for achieving one or more functions of the above exemplary embodiments to a system or an apparatus via a network or a storage medium, and of causing one or more processors of a computer of the system or the apparatus to read and execute the program. The present disclosure can also be achieved by a circuit (e.g., an application-specific integrated circuit (ASIC)) for achieving the one or more functions.

### <Effects>

As described above in the exemplary embodiments, even in a print product obtained by performing additional printing on a pre-print sheet, the influence of reflective glare is appropriately corrected, whereby it is possible to inspect the print product without decreasing the defect detection accuracy.

### Other Exemplary Embodiments

While various examples and exemplary embodiments of the present disclosure have been described above, the spirit and scope of the present disclosure are not limited to a particular description in the specification.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-110604, filed Jul. 9, 2024, which is hereby incorporated by reference herein in its entirety.

What is claimed is:

1. An inspection apparatus that, based on a reference image, inspects image data acquired from an image formed on a print product, the inspection apparatus comprising:
a reading unit configured to optically read a pre-print sheet on which information is printed in advance to generate read image data;
an image processing unit configured to acquire reference data from print data; and
a generation unit configured to combine the read image data and the reference data to generate combined image data,
wherein the generation unit generates the reference image by performing addition image processing that is a correction process for, based on correction information corresponding to a noise component of light generated by the reading unit, adding the noise component of the light on at least a region corresponding to the reference data in the combined image data.

2. The inspection apparatus according to claim 1, wherein the reference data is data acquired by performing raster image processor (RIP) processing on the print data.

3. The inspection apparatus according to claim 1, wherein the generation unit generates the reference image by executing, on the read image data, attenuation image processing that is a correction process for, based on correction information corresponding to a noise component of light in the read image data, attenuating the noise component of the light, then generating the combined image data, and executing the addition image processing on both a region corresponding to the read image data and the region corresponding to the reference data in the combined image data.

4. The inspection apparatus according to claim 3, further comprising a holding unit configured to hold a correction coefficient corresponding to the noise component of the light generated by the reading unit,
wherein the correction information to be used in the attenuation image processing and the correction information to be used in the addition image processing are information calculated based on the correction coefficient.

5. The inspection apparatus according to claim 4,
wherein the holding unit holds the correction coefficient with respect to each sheet type, and
wherein the correction information to be used in the attenuation image processing and the correction information to be used in the addition image processing are information calculated based on the correction coefficient according to the sheet type.

6. The inspection apparatus according to claim 5, further comprising:
a determination unit configured to determine, before the reading unit reads the pre-print sheet, whether the pre-print sheet is a new sheet type for which the holding unit does not hold the correction coefficient; and
a notification unit configured to prompt, in a case where the determination unit determines that the pre-print sheet is the new sheet type, a user to execute calibration.

7. The inspection apparatus according to claim 6, wherein the calibration is executed using not the pre-print sheet but a blank sheet of a same sheet type as the pre-print sheet.

8. The inspection apparatus according to claim 5, further comprising a display unit configured to display an adjustment screen for adjusting the correction coefficient held in the holding unit.

9. The inspection apparatus according to claim 3, further comprising a setting unit configured to set, in a case where the generation unit generates the reference image, whether to perform attenuation image processing for, based on correction information corresponding to a noise component of light in a region corresponding to the read image data in the combined image data, attenuating the noise component of the light, and then execute the addition image processing on both the region corresponding to the read image data having been subjected to the attenuation image processing and the region corresponding to the reference data.

10. The inspection apparatus according to claim 1, further comprising a setting unit configured to set, in a case where the generation unit generates the reference image, whether to perform processing including the addition image processing on at least the region corresponding to the reference data in the combined image data.

11. An inspection system including a printing unit configured to generate a print product based on print data, and an inspection unit configured to inspect, based on a reference image, image data acquired from an image formed on the print product, the inspection system comprising:
a reading unit configured to optically read a pre-print sheet on which information is printed in advance to generate read image data;
an image processing unit configured to acquire reference data from the print data; and
a generation unit configured to combine the read image data and the reference data to generate combined image data,
wherein the generation unit generates the reference image by performing addition image processing that is a correction process for, based on correction information corresponding to a noise component of light generated by the reading unit, adding the noise component of the light on at least a region corresponding to the reference data in the combined image data.

12. The inspection system according to claim 11, wherein the reference data is data acquired by performing raster image processor (RIP) processing on the print data.

13. The inspection system according to claim 11, wherein the generation unit generates the reference image by executing, on the read image data, attenuation image processing that is a correction process for, based on correction information corresponding to a noise component of light in the read image data, attenuating the noise component of the light, then generating the combined image data, and executing the addition image processing on both a region corresponding to the read image data and the region corresponding to the reference data in the combined image data.

14. The inspection system according to claim 13, further comprising a holding unit configured to hold a correction coefficient corresponding to the noise component of the light generated by the reading unit,
wherein the correction information to be used in the attenuation image processing and the correction information to be used in the addition image processing are information calculated based on the correction coefficient.

15. The inspection system according to claim 14,
wherein the holding unit holds the correction coefficient with respect to each sheet type, and
wherein the correction information to be used in the attenuation image processing and the correction information to be used in the addition image processing are information calculated based on the correction coefficient according to the sheet type.

16. The inspection system according to claim 15, further comprising:
a determination unit configured to determine, before the reading unit reads the pre-print sheet, whether the pre-print sheet is a new sheet type for which the holding unit does not hold the correction coefficient; and
a notification unit configured to prompt, in a case where the determination unit determines that the pre-print sheet is the new sheet type, a user to execute calibration.

17. The inspection system according to claim 16, wherein the calibration is executed using not the pre-print sheet but a blank sheet of a same sheet type as the pre-print sheet.

18. The inspection system according to claim 15, further comprising a display unit configured to display an adjustment screen for adjusting the correction coefficient held in the holding unit.

19. The inspection system according to claim 14, further comprising a setting unit configured to set, in a case where the generation unit generates the reference image, whether to execute the addition image processing on both the region corresponding to the read image data having been subjected to the attenuation image processing and the region corresponding to the reference data.

20. The inspection system according to claim 11, further comprising a setting unit configured to set, in a case where the generation unit generates the reference image, whether to perform processing including the addition image processing on at least the region corresponding to the reference data in the combined image data.
